(19) United States
(12) Patent Application Publication
(10) Pub. No.: US 2015/0106708 A1
(43) Pub. Date: Apr. 16, 2015

(54) CAPTURING NAVIGATIONS, EXPLORATIONS, AND ANALYSIS

(71) Applicants: CHARLES MONTE, San Rafael, CA (US); RICHARD RATKOWSKI, St. Peters, MO (US)

(72) Inventors: CHARLES MONTE, San Rafael, CA (US); RICHARD RATKOWSKI, St. Peters, MO (US)

(21) Appl. No.: 14/515,591

(22) Filed: Oct. 16, 2014

Related U.S. Application Data
(60) Provisional application No. 61/891,468, filed on Oct. 16, 2013.

(51) Int. Cl. G06F 3/0484

(52) U.S. Cl. CPC G06F 3/04842
USPC 715/704

(57) ABSTRACT

Various embodiments of systems and methods for capturing and sharing user's exploration and analysis are described herein. In an aspect, the method includes capturing a path traversed by a user as a thread. The thread comprises one or more user interfaces (UIs) traversed by the user in a hierarchical topology within at least one document. When the user traversed back on one or more sub-paths included within the path, one or more UIs corresponding to the one or more sub-paths is removed from the thread or reinstated in the thread. Once the path traversed by the user or the thread is captured, an option is provided for naming and storing the thread. The stored thread can be displayed, shared, annotated, and exported in other applications.

This application claims priority under 35 U.S.C. §119 to Provisional Patent Application 61/891,468, filed on Oct. 16, 2013, titled “DOCUMENT EXPLORATION TECHNIQUES, ANALYSIS, AND COLLABORATION”, which is incorporated herein by reference in its entirety.

### BACKGROUND

Documents such as financial documents, operational documents, etc., may be analyzed for various issues. For example, a financial document may be explored and analyzed when there is decrease in sales rate. Such documents include voluminous data and these data may be arranged in a hierarchical format within the documents. A user might need to perform various explorations or navigations in hunt for an issue. Usually, it is arduous to track or store these explorations and navigations for sharing or future reference.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary environment including a threadanalyzer for maintaining threads created on multi-dimensional view explorer, according to an embodiment.

FIG. 2A-FIG. 2D illustrate various options for maintaining a view of a document, according to an embodiment.

FIG. 3A-FIG. 3J illustrate a ledger document including a multi-dimensional hierarchical view explorer for exploring an identified issue, according to an embodiment.

FIG. 4 illustrates a document explored by drilling down the identified issue, according to an embodiment.

FIG. 5 illustrates a document including a thread analysis button to activate thread analysis, according to an embodiment.

FIG. 6 illustrates a threadanalyzer popover displayed on triggering thread analysis button, according to an embodiment.

FIG. 7 illustrates a thread selected from various threads rendered on the threadanalyzer popover, according to an embodiment.

FIG. 8 illustrates an exemplary financial data corresponding to the selected thread of FIG. 7, according to an embodiment.

FIG. 9 illustrates an action menu displayed for a selected thread UI, according to an embodiment.

FIG. 10 illustrates a pop up displayed upon selection of save option from the action menu, according to an embodiment.

FIG. 11 is a graphical user interface illustrating an icon for displaying stored threads, according to an embodiment.

FIG. 12A-FIG. 12B illustrate activating the threadanalyzer to display thread in a tile pane, according to another embodiment.

FIG. 12C illustrates an action menu displayed for a selected document in the tile pane, according to an embodiment.

FIG. 13A-FIG. 13R illustrate lateral move and drill down relative to a thread, according to an embodiment.

FIG. 14 is a graphical user interface illustrating a home page of a user, according to an embodiment.

FIG. 15A-FIG. 15D illustrate switching the threadanalyzer in manual mode, according to an embodiment.

FIG. 16 illustrates a tile pane including saved thread, according to an embodiment.

FIG. 17A-FIG. 17C illustrate filtering a document based upon selection within a cell action menu, according to an embodiment.

FIG. 17D illustrates capturing the filtered document as a thread in a manual mode, according to an embodiment.

FIG. 18 a flow chart illustrating a process of tracking and capturing user's navigations and explorations, according to an embodiment.

FIG. 19 is a block diagram of an exemplary backend for capturing, storing, and communicating threads created on the multi-dimensional view explorer, according to an embodiment.

FIG. 20 is a block diagram of an exemplary computer system, according to an embodiment.

### DESCRIPTION

Embodiments of techniques for capturing explorations, navigations, and analysis are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “an embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in a suitable manner in one or more embodiments.

A document may refers to a written, printed, or electronic matter that provides information or serves as an official record. The document may comprise a record, a report, or a file and is used for maintaining business transactions. The document may be a financial document, an operational document, etc. The financial document refers to a document or a file for maintaining financial data. In an embodiment, the financial document may be a ledger document for recording and totaling monetary transactions. In an embodiment, the ledger document includes, but is not limited to, general ledgers (GL), balance sheet, profit and loss (P&L) statements, backlogs reporting, and low level invoices, etc. The documents may be analyzed at various stages and for various issues, e.g., when sales result appears incorrect.

A problem finder refers to an application which is executed in backend to determine potential issues. The problem finder application programmatically performs “rules-based” analysis of the document (e.g., financial documents) for identifying potential errors or issues. The problem finder provides problem indications on individual data “cells” within the document. In an embodiment, the problem finder may be integrated into other applications, e.g., financial application. In another embodiment, the problem finder may be a separate application which is communicatively coupled to other applications. The problem finder enables displaying “potential problem” indications on specific financial numbers or data cell in the financial document like a spreadsheet to provide “clues” during problem-finding investigations. In an embodiment, rules-based analysis is comprised of an array of conditions, actions, parameters, and formulas that may be predefined by a user.

In an embodiment, based upon the identified problem, the investigations are performed relative to various parameters namely, but not limited to, financial time periods (e.g., Q1, Q4, March 2012, etc.) and a type of document (e.g., a GL document, P&L statement, etc.). Once values for the parameters are provided, the data within the document is filtered based upon the selected parameters and their selected values. The user can perform multiple filtrations of data based upon various parameters and/or its values to investigate the problem. Once the problem is investigated and identified, the filtered document indicating the problem may be saved as a ‘UI view’. The ‘UI view’ may be considered as a kind of snapshot of screen or the filtered document. A user can provide a personalized name for the ‘UI view’ and can save the ‘view’ for future reference. In an embodiment, the ‘views’ are maintained by a ‘view analyzer.’ The view analyzer may save the snapshot in at least one of a live application link (e.g., uniform resource locator or URL) or screen capture (e.g., portable document format or pdf). The screen capture is frozen in time when the snapshot is taken, whereas, the snapshot in live app link can be converted from a frozen-in-time to real-time and vice versa. In an embodiment, various actions can be performed on the saved ‘view’ such as, but not limited to, deleting the view, renaming the view, searching the view, etc.

In various embodiments, a multi-dimensional view may be created for the document configured in a hierarchical topology. In hierarchical topology, the data within the document are arranged and can be explored in the multiple level hierarchical fashions. Therefore, the data or fields within the document can be drill down or drill up in a hierarchical fashion. The multi-dimensional view refers to a hierarchical path traversed or explored during an analysis. These views are structured and explored in a multiple level hierarchical fashion. In an aspect, the multi-dimensional view enables a user to manipulate views or paths (explore alternate paths) more efficiently and continuously, depending on varying thought process during investigation. In an embodiment, the ‘multi-dimensional UI view’ is referred to as a ‘thread’.

A ‘thread’ as referred herein may be a flow of analysis performed by a user. Alternately, it can be said that the ‘thread’ is a path involving various navigations and selections in search of a desired data. In an embodiment, the ‘thread’ or path is represented as a string. Various threads (navigations and selections) may be explored while performing financial analysis or while investigating a problem. The ‘threads’ may be saved and organized so that they can be reused and retraced later. In an embodiment, the threads are organized, stored, and maintained by a ‘threadanalyzer’.

A ‘threadanalyzer’ refers to an application which operates in backend to automatically track and record the ‘threads.’ The ‘threadanalyzer’ tracks and records “on-the-fly” unstructured explorations during a hunt for a problem. In an embodiment, the tracked explorations (threads) are stored automatically by the ‘threadanalyzer.’ In another embodiment, upon receiving user's instruction, the ‘threads’ are stored. In an embodiment, as the user drills down the multi-dimensional hierarchical document, the ‘threadanalyzer’ automatically creates threads based upon the path explored. In an embodiment, when the user backs up through the thread (drills up), and at some location in the thread selects a new entry point in a lateral move, the ‘threadanalyzer’ automatically deletes or removes the previous thread path below that entry point and based on new drill-down moves, creates a new thread from the new entry point. If the user returns to the new entry point and in a lateral move selects the original entry point, the threadanalyzer reinstates the original thread. The threadanalyzer may save the thread as at least one of a live application link (e.g., URL) or screen capture (e.g., pdf/image). The thread stored as screen capture is frozen in time when the snapshot is taken, whereas, the UIs within thread stored as live app link can be converted from a frozen-in-time to real-time and vice versa. In another embodiment, the ‘threadanalyzer’ may operate in a manual mode which allows user to create ‘customized threads’ by selecting only the UIs or screen capture that they want to include in the thread. The ‘thread’ involved in identifying an issue and considered useful may be customized (e.g., named) and saved by the user. In an embodiment, the ‘threadanalyzer’ enables a user to isolate the ‘thread’ and store it. The stored threads may be referred or reused later. In an embodiment, upon receiving user's selection of a thread from the stored threads, the ‘threadanalyzer’ automatically redirects to land on a user interface (UI) or page associated with the selected thread.

A collaborator refers to a communication tool or channel communicatively coupled to the threadanalyzer. In an embodiment, the collaborator comprises multiple modes of communication including, but not limited to, email, short messaging service (SMS), instant messaging, corporate blogs or networks, in-app messaging, etc. In an embodiment, the collaborator may be embedded within the threadanalyzer. Therefore, the thread or other information related to analysis can be sent, shared, or communicated to various recipients through the collaborator. In an embodiment, the accounting document screen captures is sent to the recipients not conversant with complex accounting applications to enable the recipient to easily view and understand the issue.

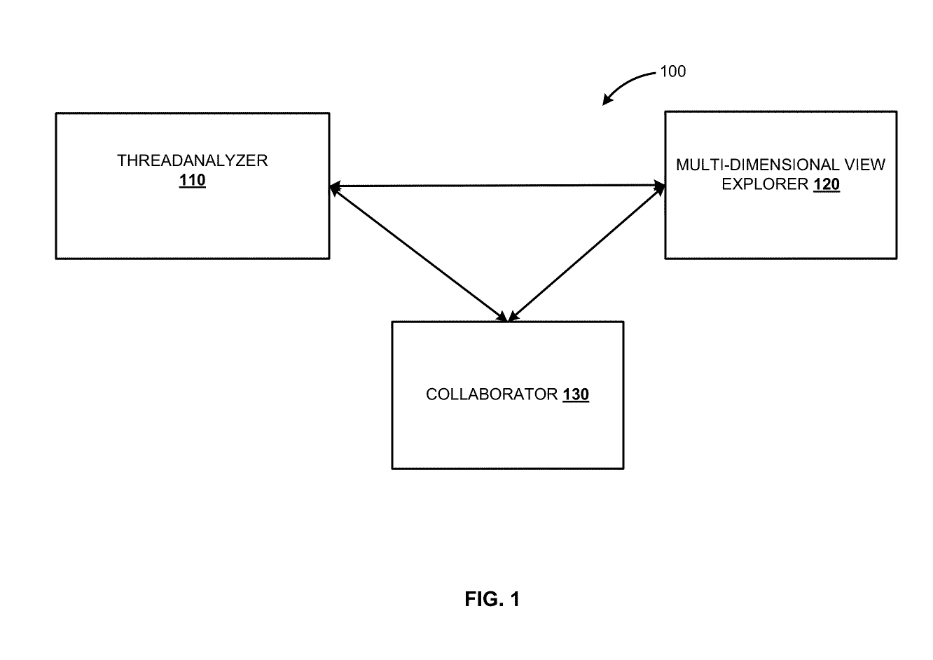

One or more embodiments described herein provide for maintaining and analyzing threads and collaborating with broad range of recipients during analysis. The following exemplary embodiments illustrated with reference to FIG. 1 to FIG. 20, describe in detail the threadanalyzer and collaborator with reference to financial analysis. However, it should be appreciated that the embodiments can be implemented for other analysis (e.g., operational analysis) in similar way. Also, it should be understood that the embodiments can be implemented on various computing devices including laptops, desktops, tablets, and other hand held devices.

FIG. 1 is a block diagram illustrating an exemplary environment 100 including a threadanalyzer 110 for analyzing one or more threads created on a multi-dimensional view explorer 120. The threadanalyzer 110 is communicatively coupled to the multi-dimensional view explorer 120. In an embodiment, the threadanalyzer 110 is a part of the multi-dimensional view explorer 120. The multi-dimensional view explorer 120 enable users to explore (e.g., drill up/down) a document, e.g., a ledger document, in a multi-dimensional hierarchical fashion. Various paths may be explored to discover a desired data or investigate a problem. The paths may be saved as a separate threads. In an embodiment, the threadanalyzer 110 traces various views (multi-dimensional views) traversed by a user within the document and saves as threads. In an embodiment, the threadanalyzer 110 maintains and stores the threads. The user can analyze one of the stored threads. When a thread is selected for analysis, the threadanalyzer 110 redirects to a user interface (UI) rendering financial data related to the selected thread. In an embodiment, the threadanalyzer 110 enables the user to perform various actions on the selected thread or actions (e.g., name/rename the selected thread, share the selected thread, etc.) relative to the selected thread.

The thread may be shared through a collaborator 130. The collaborator 130 is communicatively coupled to the threadanalyzer 110 and/or the multi-dimensional view explorer 120. In an embodiment, the collaborator 130 may be embedded within the threadanalyzer 110. In an embodiment, the collaborator 130 may be embedded within the multi-dimensional view explorer 120. The collaborator 130 enables the user to collaborate, send, and share information related to the thread or other relevant information such as a screen capture to various recipients. In an embodiment, the collaborator 130 also enables users to send a reference of the thread for recipients to understand the path used in investigating a problem. Therefore, the multi-dimensional hierarchical document can be easily analyzed and shared.

In an embodiment, an algorithm (e.g., state-of-art algorithms) is executed in backend to identify issues (e.g., variance). In an embodiment, such algorithms may be termed as ‘problem finder’. Once the issues are identified and highlighted in the document by the algorithm, the user can drill down or explore the document (creates various threads) to investigate the identified issues. Once the issues are identified/indicated, the user can explore and analyze the document to investigate the issues. In an embodiment, the document can be explored, analyzed, and filtered using various techniques. In an embodiment, the document being analyzed includes a threadanalyzer icon (not shown). In an embodiment, the threadanalyzer icon is displayed on the documents once the threadanalyzer 110 gets integrated with the multi-dimensional view explorer 120. In an embodiment, while exploring, filtering, or analyzing the document various views of the document can be created and saved.

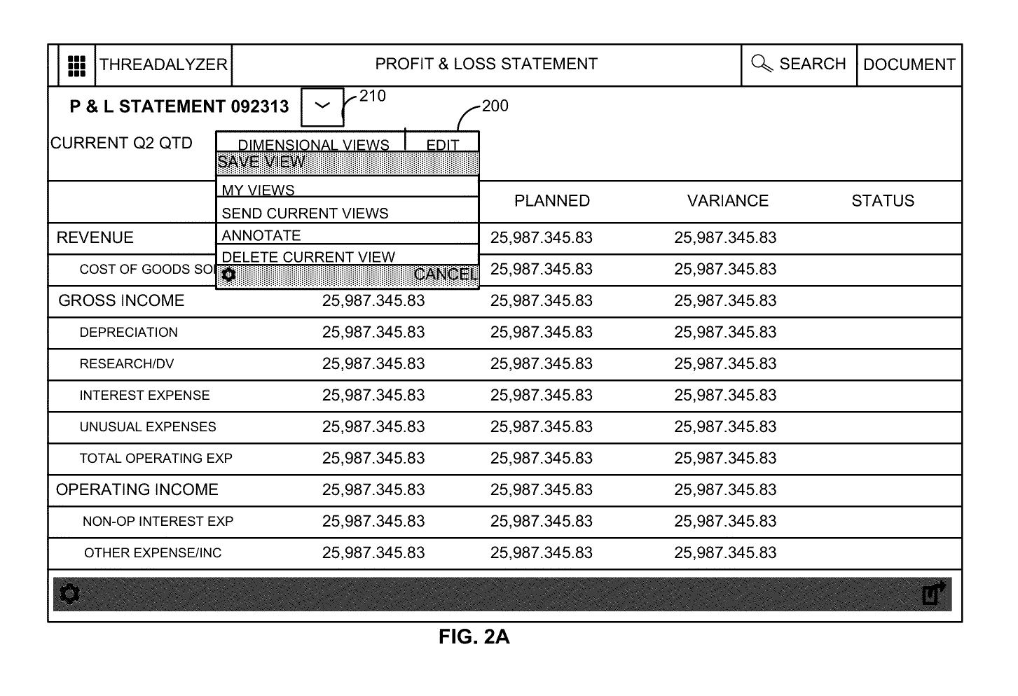

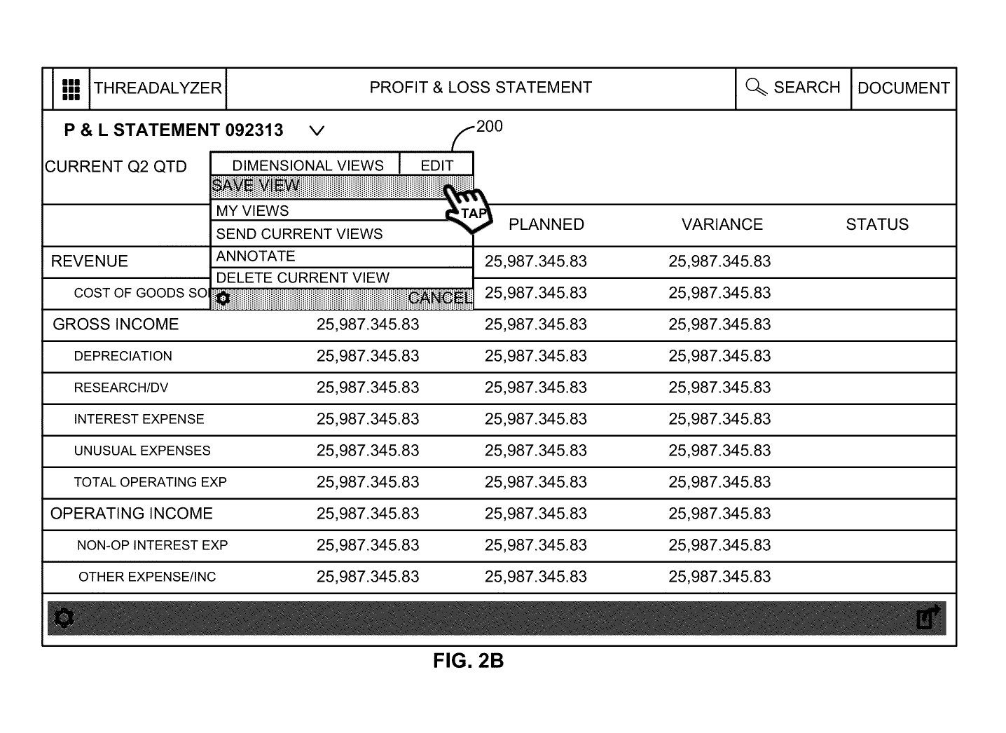

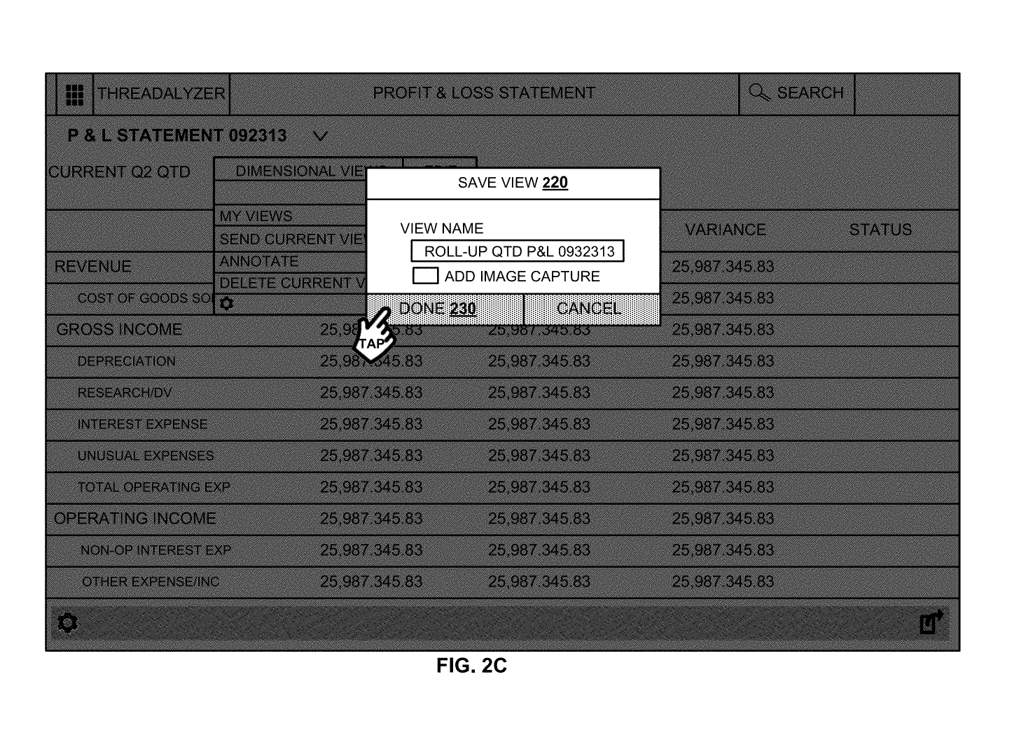

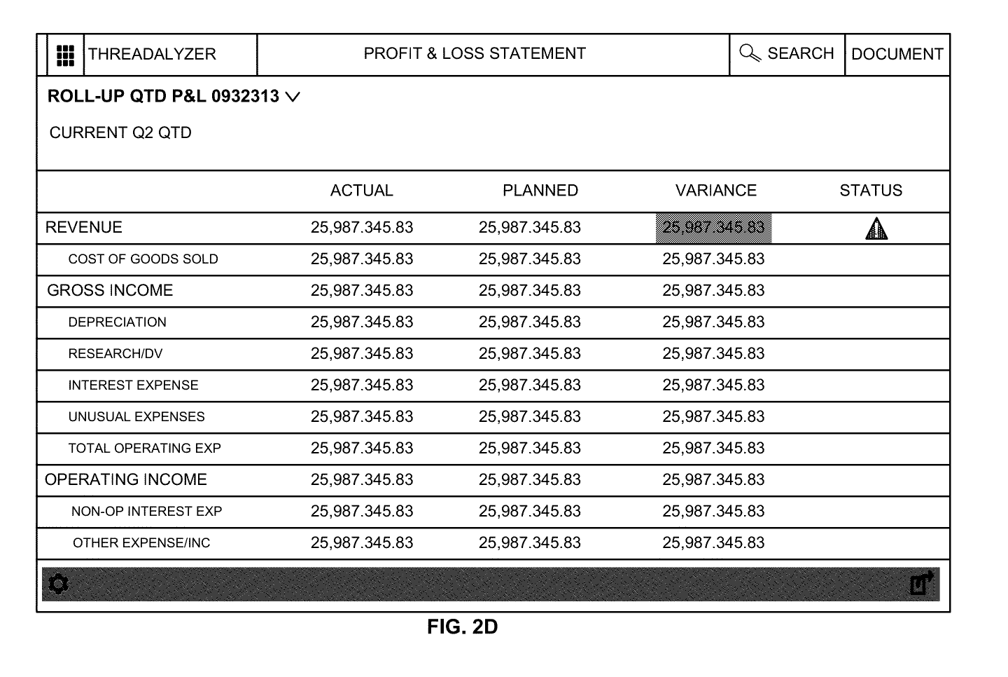

FIG. 2A-FIG. 2D illustrate various options for maintaining a view of a document, according to an embodiment. FIG. 2A shows a document popover menu 200 displayed when the user taps on document details icon (e.g., a drop-down icon 210). The document popover menu 200 includes various options for maintaining a view for the document (e.g., P & L statement 092313). The options include, but are not limited to, saving a current view (save view), displaying all stored views (my views), sending the current view, deleting the current view, and annotating the current view, etc. Referring to FIG. 2B, when the user selects ‘save view’ option from the document popover menu 200, a ‘save view’ pop-up 220 (FIG. 2C) is displayed. In the ‘save view’ pop-up 220, the user enters a name for the current view to be saved, e.g., Roll-Up QTD P&L 092313, to save the current view with the entered name. Once the name is entered, the user taps on a ‘save’ or ‘done’ button 230 to save the current view with the entered name. In an embodiment, the “save view” analyzer function saves the current screen view as an individual “snapshot” of the screen as at least one of an app link and screen capture (image file formats such as portable network graphics or png, pdf, etc.) which may be later used to communicate to a broad array of recipients. The view gets saved to ‘my views’ directory and screen header reflects this name change, as shown in FIG. 2D. In an embodiment, the ‘view’ is also automatically saved as a ‘thread’ view.

The document view analyzer saves a snapshot as at least one of a live application link (e.g., URL) or a screen capture (e.g., pdf/image). The screen capture may be an image file (e.g., a pdf file, graphic interchange format (gif) file, power point presentation (ppt) file, etc.) and is frozen in time when the screen capture or snapshot is taken. The snapshot saved as the live app link view can be converted from a frozen-in-time to real-time and vice versa. In an embodiment, the document includes icons (not shown) to toggle between the frozen-in-time and current or real-time. Therefore, the table data can be compared between these two time parameters. The screen capture or view in image version is not displayed in alternate times.

In an embodiment, a multi-dimensional view may also be created and maintained. The multi-dimensional view illustrates a hierarchical “tree-lists” which is used to explore financial data hierarchies. There may be various ways to drill down into hierarchical data to select multi-dimensional view namely, but not limited to, a single dimension selection and a dynamic multi-select hierarchical tree selection. In an embodiment, for single dimension selection, single commands are repeatedly used to drill-down and display a category one hierarchical level at a time, e.g., in a “view by” popover menu. Each time a category is repeatedly selected, a new view is displayed starting with the highest hierarchical level to the lowest level.

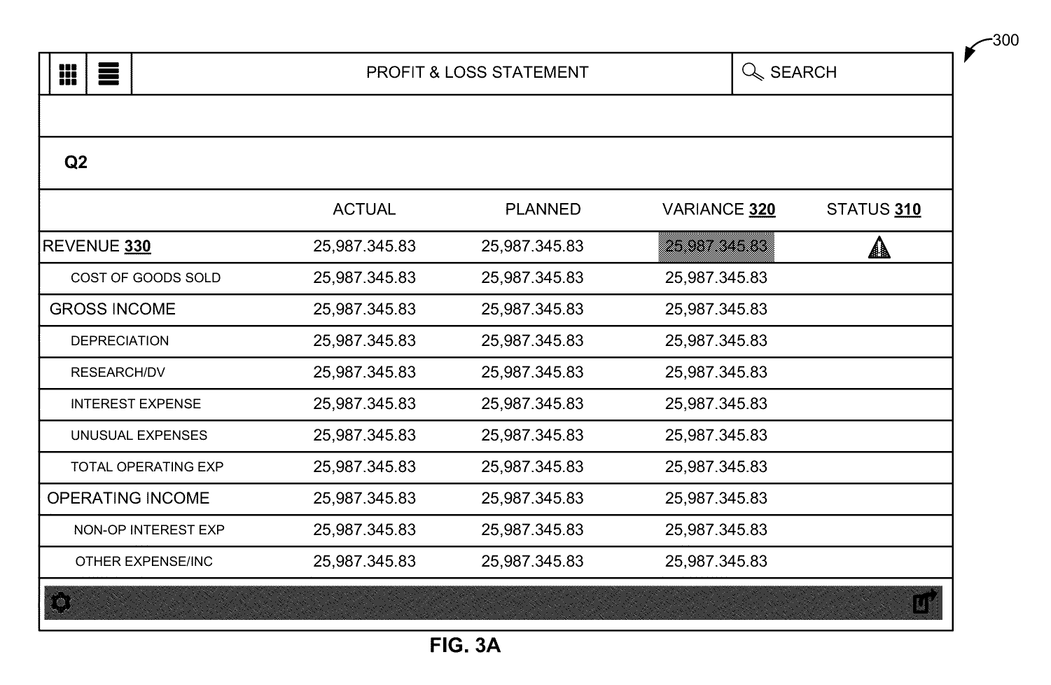

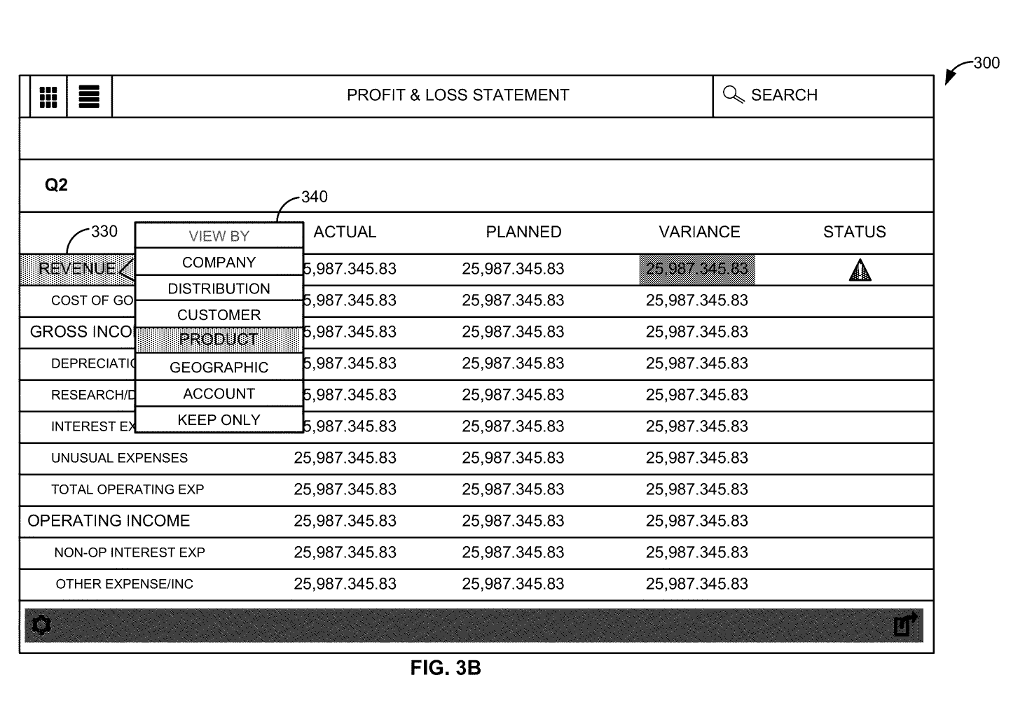

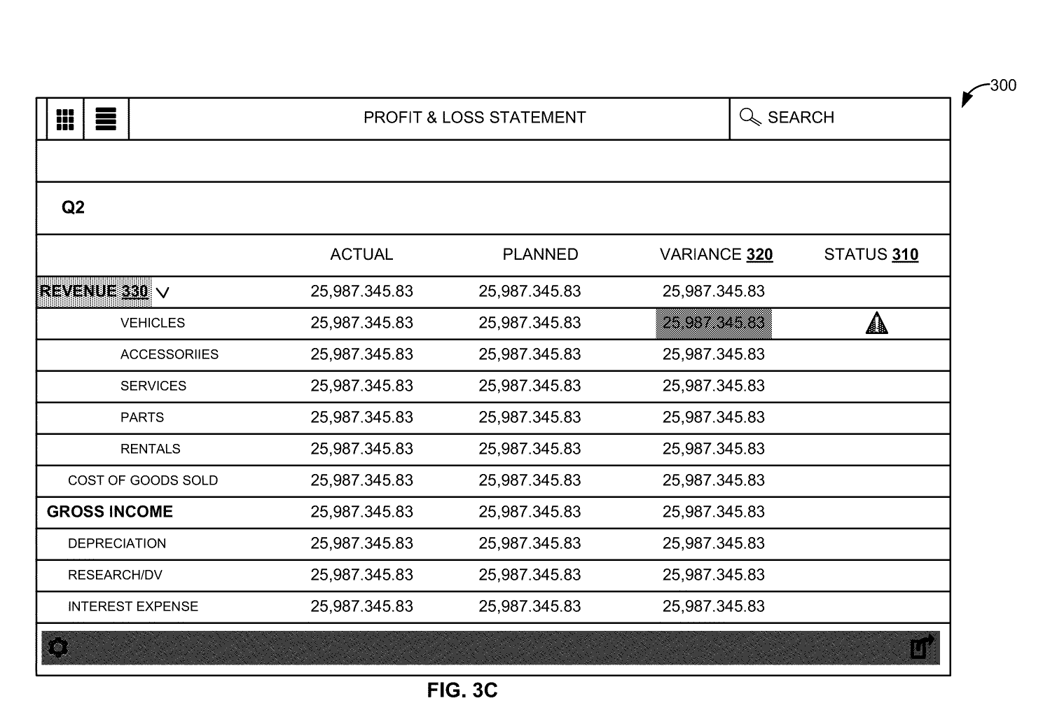

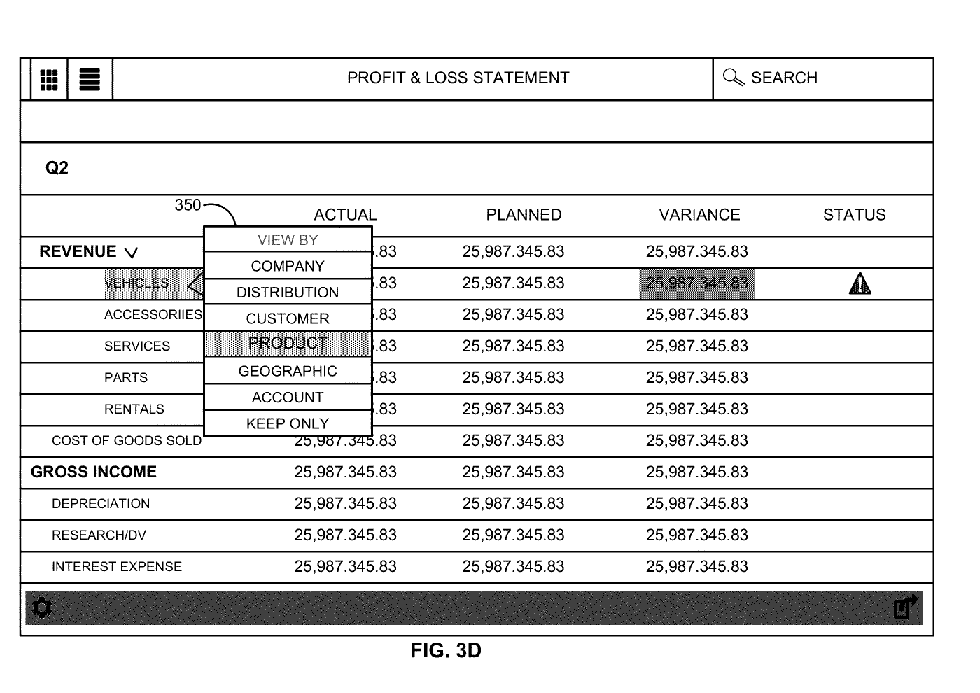

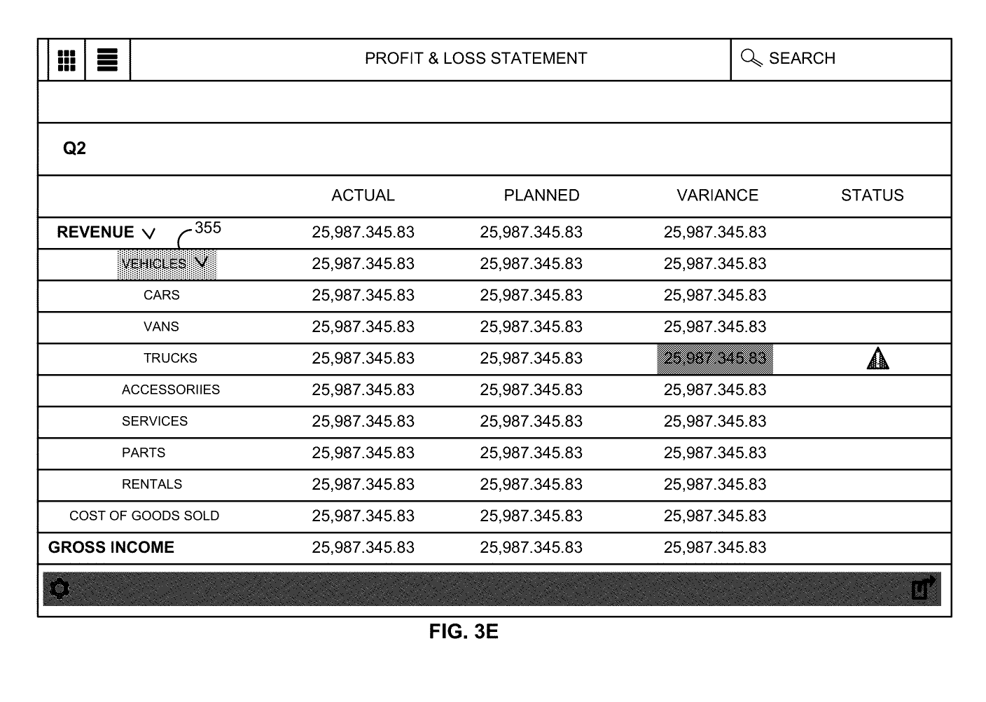

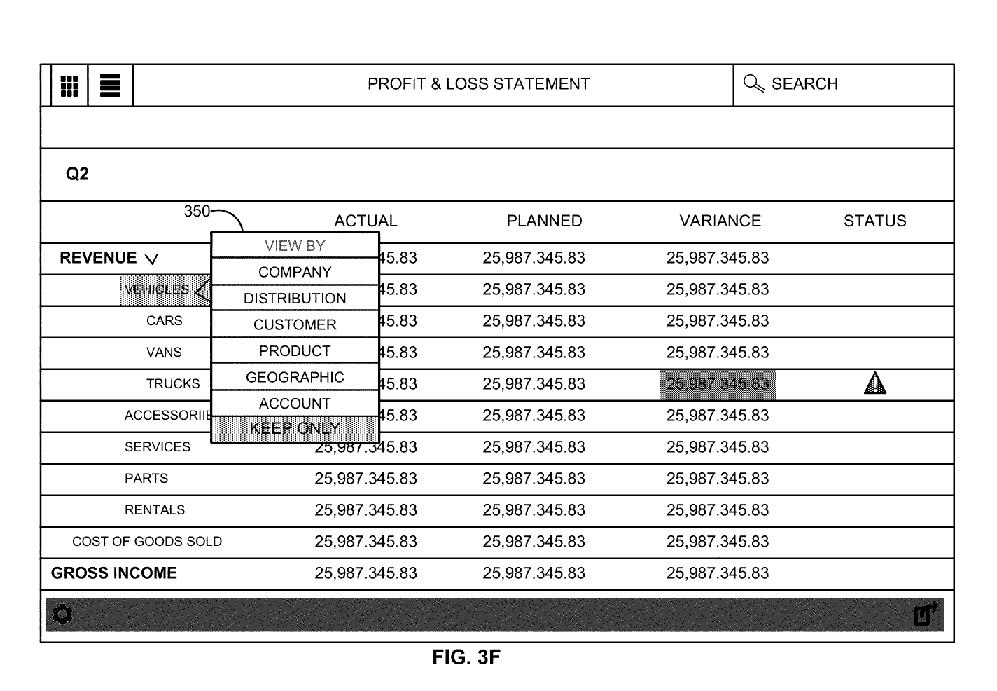

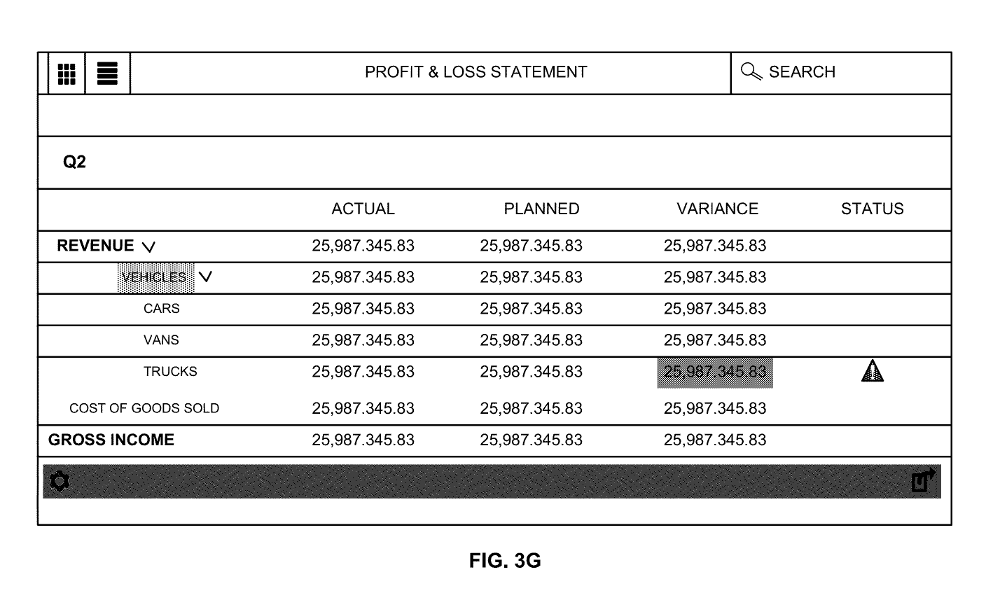

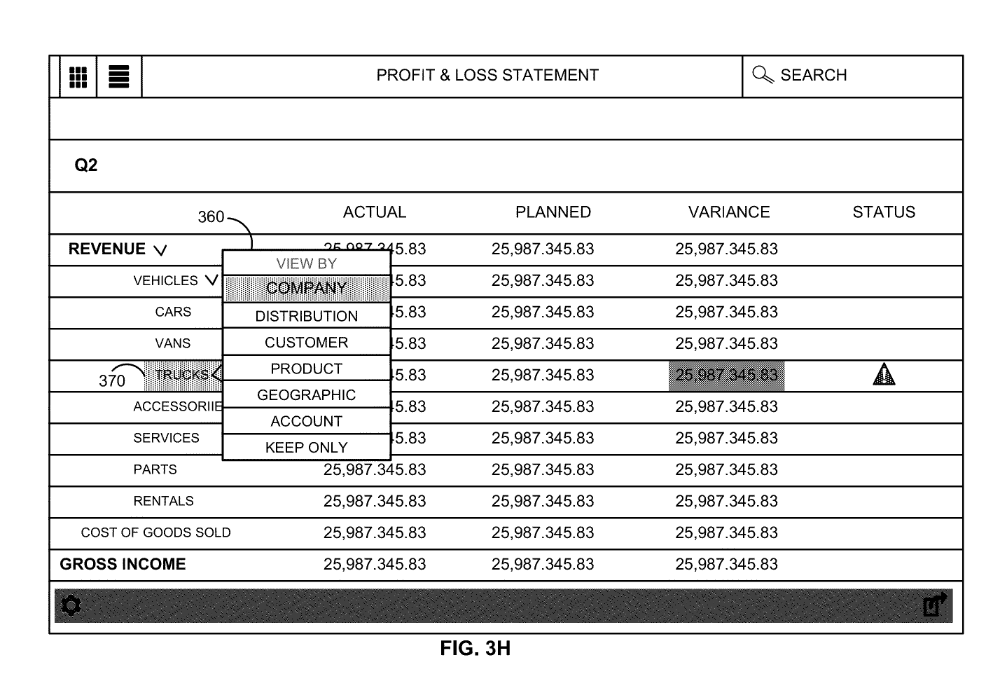

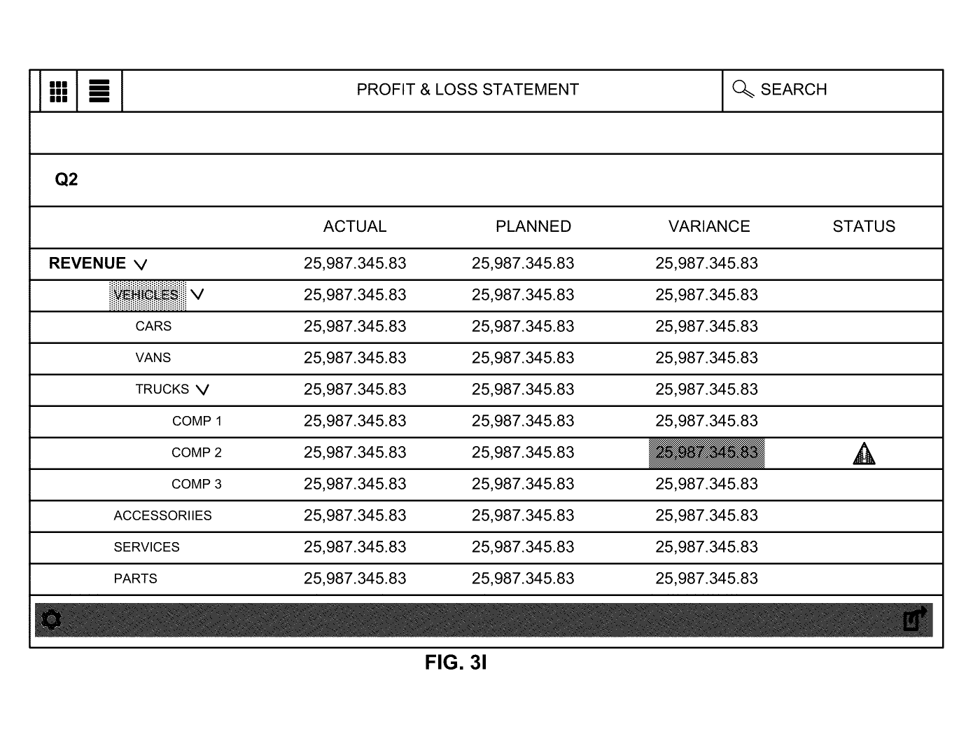

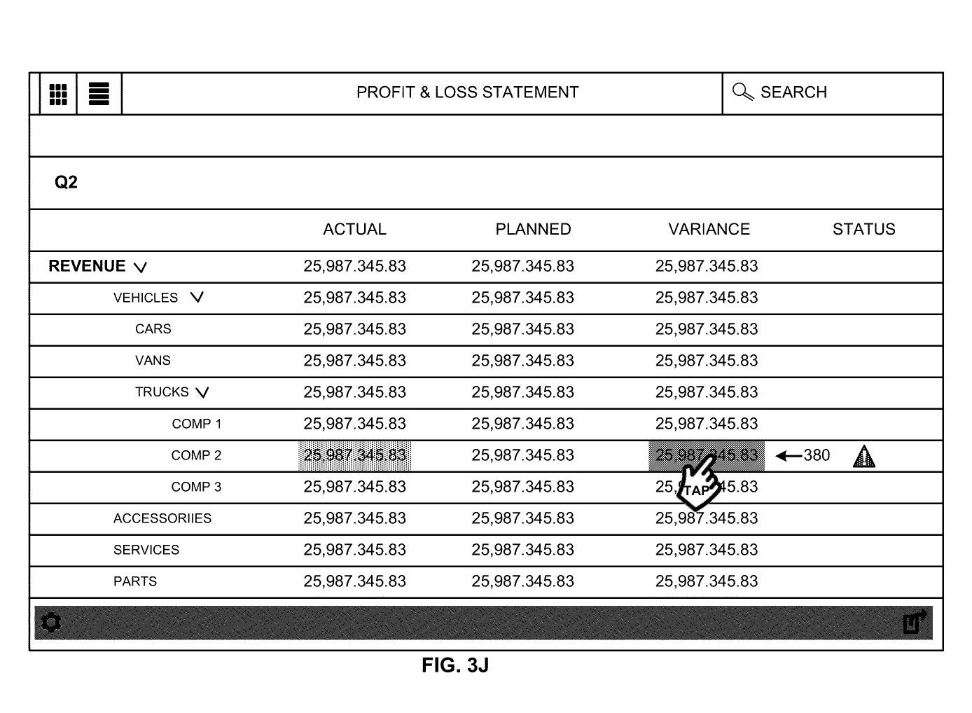

FIG. 3A-FIG. 3J show various multi-dimensional hierarchical views for a P&L statement document with single dimension selection, as an example. Referring to FIG. 3A, the P&L statement document 300 shows a potential problem in Q2 revenue. As discussed, the problem is determined programmatically by executing the algorithm (problem finder) in the backend. Upon determination, the problem is highlighted in the P&L statement document 300. In an embodiment, a status column 310 indicates the problem by displaying an ‘alert icon’ for the revenue. The specific problem may be indicated by color highlighting. In an embodiment, the color highlight may incorporate different colors depending upon the severity of the issues. For example, a variance value 320 for the revenue is highlighted to indicate the problem is associated with the variance value 320 of the revenue. The user can investigate the indicated problem.

For investigating the problem, the user selects (taps on) a revenue row label (e.g., revenue 330). In response, hierarchical dimension options, e.g., a menu ‘view by’ 340 (FIG. 3B) corresponding to the revenue 330 is rendered. The menu ‘view by’ 340 provides various options for filtering or drilling-down the revenue 330, e.g., the revenue can be displayed or filtered by ‘company’, ‘customer’, ‘product’, etc. In another embodiment, when a user selects (taps on) the revenue row label (e.g., revenue 330), a row action menu (not shown) is displayed. The row action menu includes the ‘view by’ option which provides various options for filtering or drilling-down the revenue, ‘pivot rows to columns’ to change document layout (e.g., show rows as columns) for purpose of analysis, ‘keep only’ to keep just the selected revenue row, and ‘remove only’ to remove just the selected row, etc. The ‘pivot rows to columns,’ the ‘keep only’ and ‘remove only’ are kind of document layout action. Similarly, when the user selects (taps on) a column element (e.g., actual), a column action menu (not shown) is displayed. The column action menu includes options such as ‘pivot columns to rows’ to change document layout (e.g., show columns as rows) for purpose of analysis, ‘keep only’ to keep just the selected column, and ‘remove only’ to remove just the selected column, etc.

Referring back to FIG. 3B, the user can select one of the options from the ‘view by’ 340. For example, the user selects the option ‘product’, as shown in FIG. 3B. Upon selecting the ‘product’, the revenue is displayed by product. FIG. 3C shows revenue 330 by product categories displayed under revenue arrow icon. As shown, the product categories include ‘vehicles’, ‘accessories’, ‘services’ ‘parts’, ‘rentals’, etc. In an embodiment, the revenue is highlighted (e.g., blue color) to show context of last invoked action. In an embodiment, this highlighting fades out not to distract the user. As shown, the alert icon or alert highlighting (e.g., red highlighting) got shifted to ‘vehicle’ variance of the product categories. Therefore, it can be identified that the revenue problem is associated with the product ‘vehicle’.

Referring to FIG. 3D, for further investigation, the user selects (taps on) the ‘vehicle.’ In response, hierarchical dimension options (e.g., menu 350) corresponding to the vehicle is rendered. The menu 350 provides various options for filtering the product ‘vehicle’ by ‘company’, ‘customer’, ‘product’, etc. The user can select one of the options. For example, the user selects the option ‘product,’ shown as highlighted area. Upon selecting the ‘product,’ the vehicle is displayed by product. FIG. 3E shows vehicle 355 by product categories displayed under vehicle arrow icon. For example, the product categories under vehicle include ‘cars’, ‘vans’, and ‘trucks’. In an embodiment, the vehicle is highlighted (e.g., blue color) to show context of the last invoked action. In an embodiment, this highlighting fades out not to distract the user. As shown, the alert icon or highlighting (e.g., red highlighting) now got shifted to ‘trucks’ variance of the product categories. Therefore, it can be identified that the problem is associated with the product ‘trucks’ variance of the vehicle.

Upon identifying the problem, the user may desire to focus on the financial data corresponding to the revenue of ‘vehicle’ and clear the screen or other variance (e.g., ‘accessories’, ‘service’, ‘parts’, etc) which is of no further interest. In an embodiment, referring to FIG. 3F, the user may again selects (taps on) the ‘vehicle’. Upon selecting the ‘vehicle,’ the hierarchical dimension options (e.g., menu 350) corresponding to the vehicle is rendered. One of the options within the menu is ‘keep only.’ The user taps on the option “keep only” to only keep the financial data corresponding to the revenue of ‘vehicles’ and remove other data on the screen, as shown in FIG. 3G. In an embodiment, when the user re-opens the menu 350 again after “Keep Only” has been selected (as shown in FIG. 3F), the “Keep Only” gets changed to “Restore All Rows.” Referring back, as the alert icon or alert highlighting (e.g., red highlighting) is indicated on the ‘trucks’ 370 the user taps on the ‘trucks’ 370 to display the hierarchical dimension options (e.g., menu 360) corresponding to the ‘trucks’ 370, as shown in FIG. 3H.

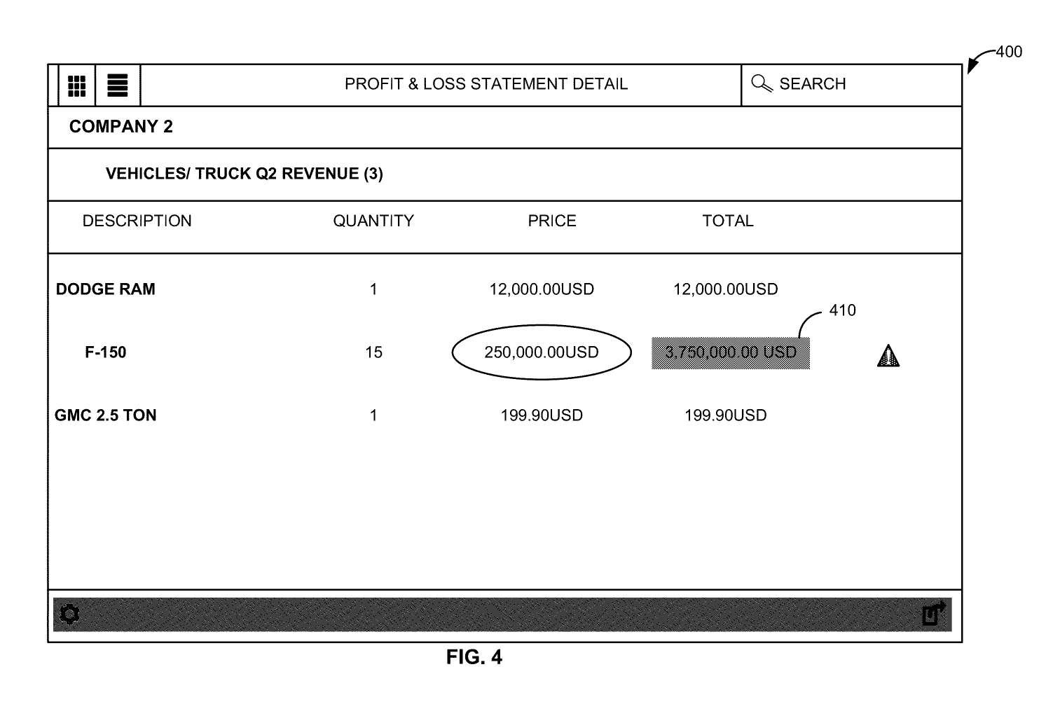

In an embodiment, the user may desire to investigate the ‘truck’ by company and therefore, the user selects ‘company’ (highlighted area) on the menu. Referring to FIG. 3I, when the user selects the ‘company,’ the financial data corresponding to ‘truck’ revenue is displayed by companies. Truck by company categories are displayed under trucks arrow icon. In an embodiment, the truck is highlighted (e.g., blue color) to show context of last invoked action. In an embodiment, this highlighting fades out not to distract the user. As shown, now the alert icon or highlighting is displayed on ‘company 2’ (e.g., COMP 2) variance of the truck. Therefore, it can be identified that the revenue problem of truck is associated with the company 2. Referring to FIG. 3J, the user desires to drill down to ‘actual revenue number’ for company 2 trucks and selects (taps on) the corresponding cell 380. In response to the selection on the cell, financial data corresponding to Q2 trucks revenue for company 2 is displayed, as shown in FIG. 4.

FIG. 4 shows the P&L statement Detail document 400 including financial data corresponding to Q2 for trucks revenue for company 2. As shown, the alert is now displayed on total sales for the truck model F-150, shown as highlighted area 410.

Once the problem is identified, the user may want to save the hunt or search. In an embodiment, the threadanalyzer 110 integrated with the multi-dimensional view explorer 120 automatically tracks and saves the exploration/search as thread and these threads can be viewed by activating or opening the threadanalyzer. In an embodiment, the user can also communicate these finding or threads to required recipients such as company 2 controller.

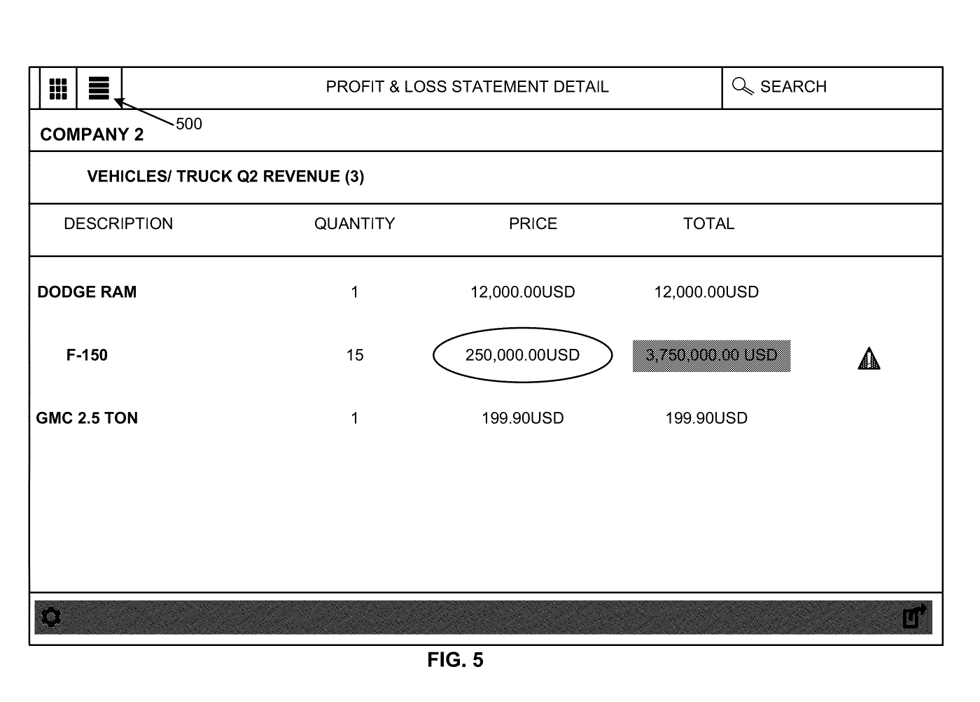

Referring to FIG. 5, the threadanalyzer can be opened by selecting (tapping) a thread analysis button 500. Once the thread analysis button 500 is selected, a threadanalyzer UI (not shown) is displayed. In an embodiment, the threadanalyzer UI may be a full screen UI.

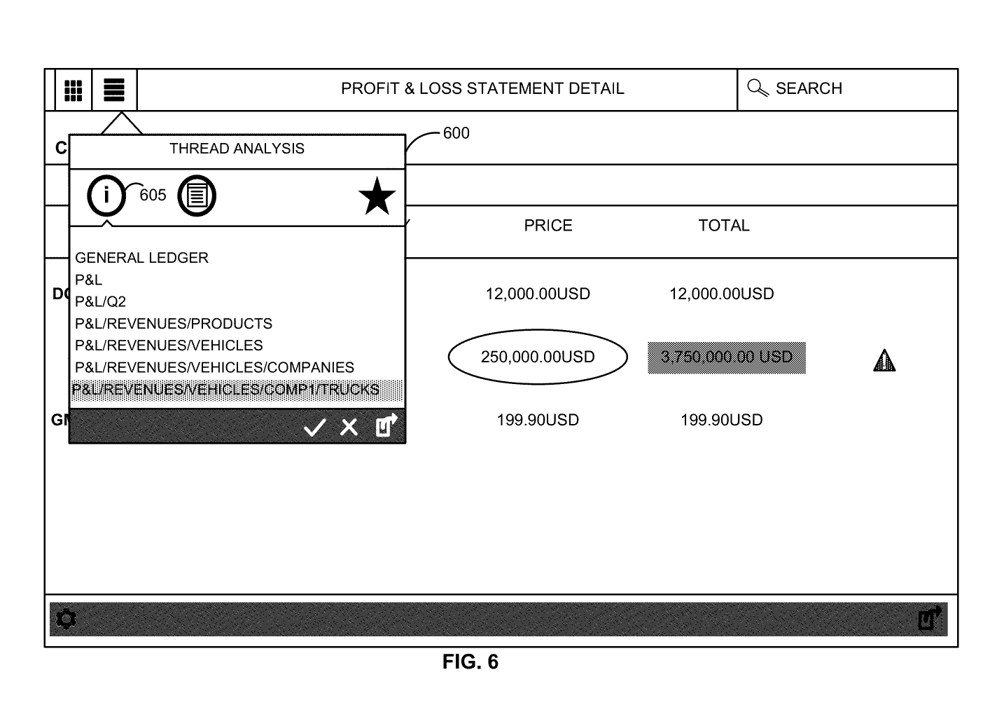

In another, embodiment, the threadanalyzer UI may be displayed as a threadanalyzer popover 600 (FIG. 6). The threadanalyzer popover 600 contains links to various document UI “views” in the sequential drill-down order as created by the user during explorations. In an embodiment, the drill-down order may be ‘top-down’, e.g., the top level is at the top of the list and the lowest hierarchical level is at the bottom of the list. In an embodiment, the drill-down order may be ‘bottom-up’, e.g., the top level is at the bottom of a list and the lowest hierarchical level is at the top of the list. Selecting a thread “jumps” to that UI view in the drill-down and closes the threadanalyzer popover 600. In an embodiment, the threadanalyzer popover 600 includes one or more icons for performing thread analysis. Under one of the icon (shown as ‘i’ 605), all the traversed or saved thread UIs are displayed. In an embodiment, the thread UIs are displayed in sequence according to the hierarchical order in which the thread is traversed or created. A thread UI currently in view is highlighted, e.g., with blue color.

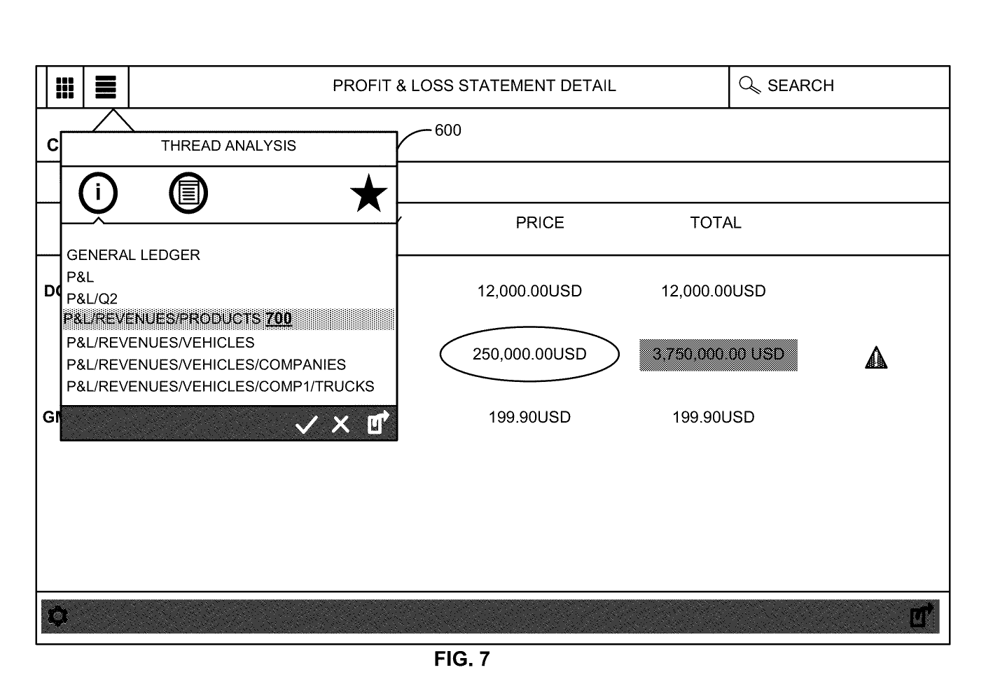

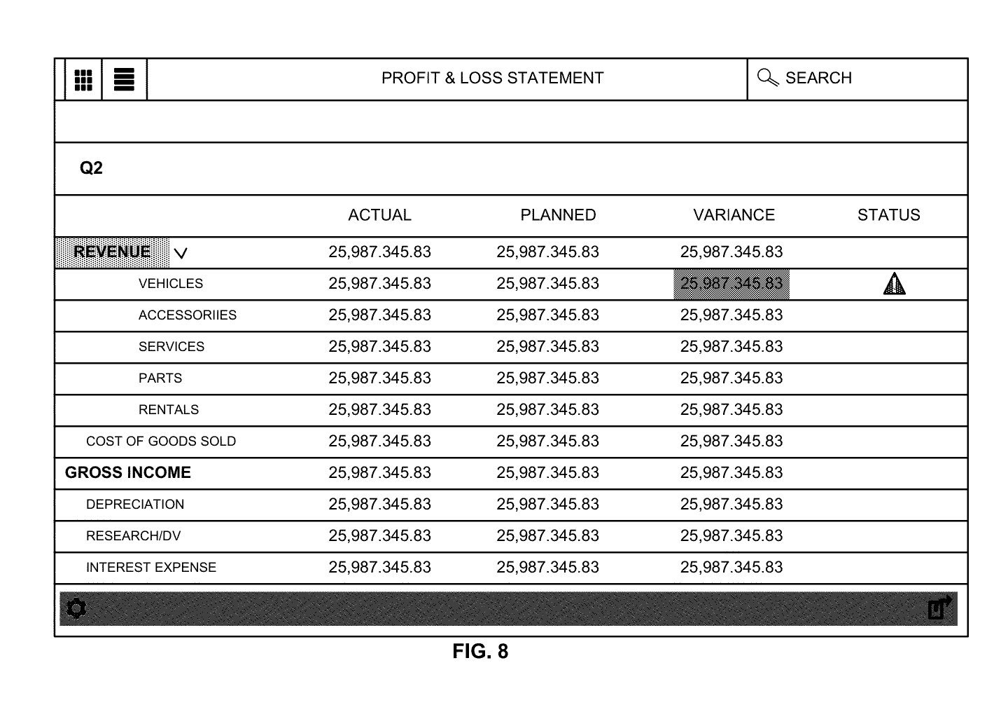

In an embodiment, the user can select any of the displayed thread UIs, e.g., “P&L revenues/products,”700 as shown in FIG. 7. Based upon the selection, financial data corresponding to the selected thread UI e.g., “P&L revenues/products”, are displayed as shown in FIG. 8.

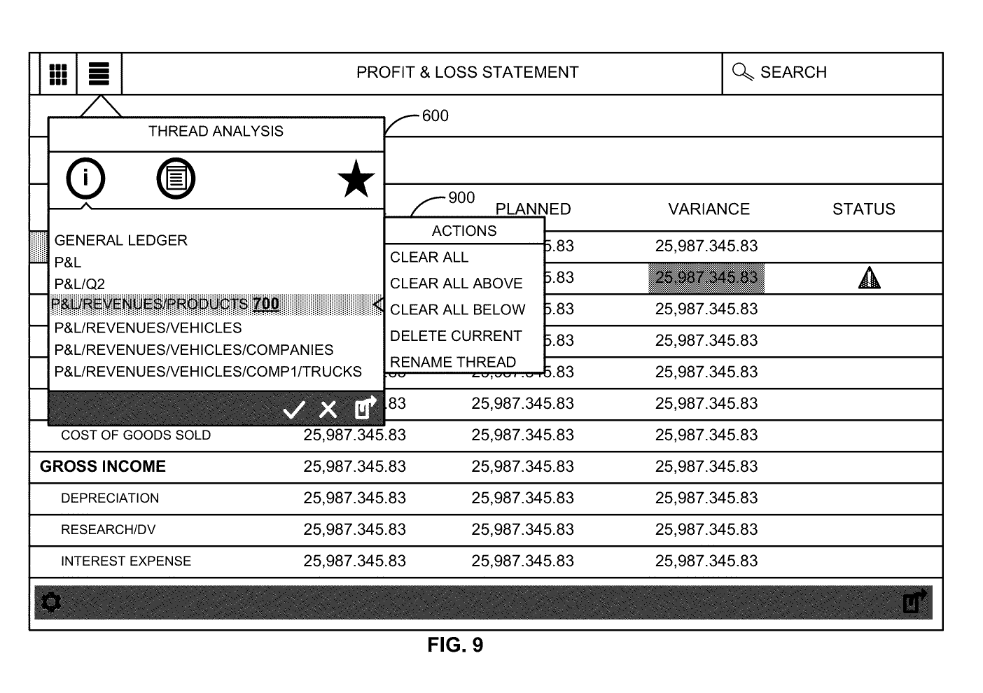

Referring to FIG. 9, the user can right click on the selected thread UI “P&L statement/revenues/products” 700 to open hierarchical dimension options (e.g., a menu 900). The menu 900 displays various actions that can be performed on or relative to the selected thread UI (P&L Statement/Revenues/Products). In an embodiment, the actions include, but is not limited to, ‘clear all’ to clear or remove all the displayed thread UIs in the thread, ‘clear all above’ to clear all those thread UIs which are positioned or rendered above the selected thread UI, ‘clear all below’ to clear all those thread UIs positioned below the selected thread UI, ‘delete current’ to delete the current or selected thread UI, and ‘rename’ to rename the selected thread UI from that of the system assigned default name.

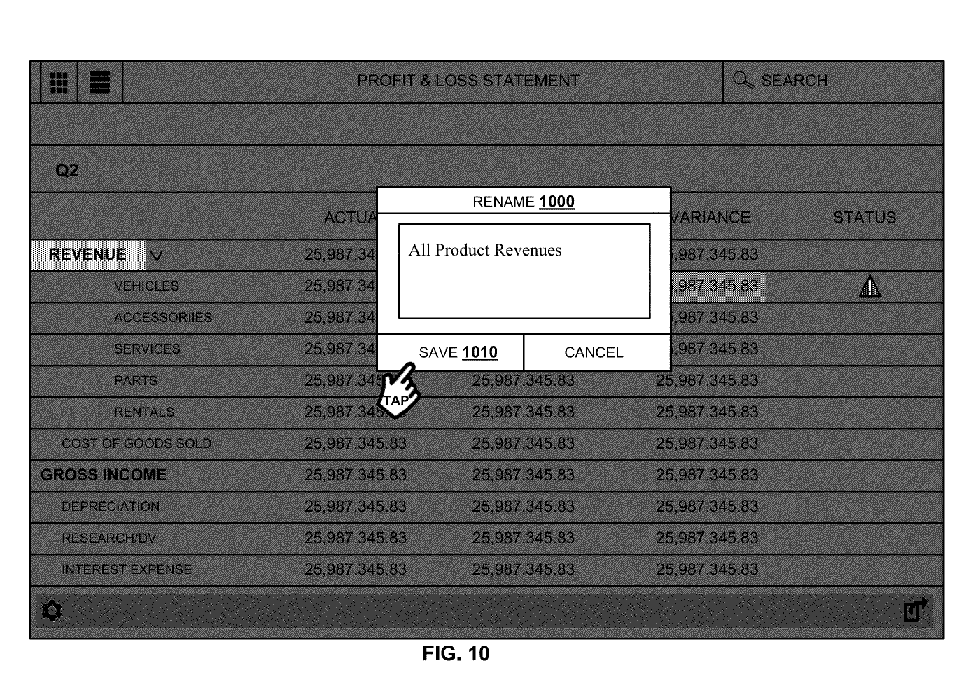

In an embodiment, when the option ‘rename’ from the menu 900 is selected, a pop up 1000 (FIG. 10) is displayed. The user can enter a new name for the selected thread UI, e.g., “P&L Revenues Products” to “All Product Revenues” and then press a ‘save’ button 1010 to save the thread UI ‘P&L statement/revenues/product’ as “All Product Revenues”. Therefore, the user can enter a personalized name for the selected thread UI and the thread will be displayed with the new name.

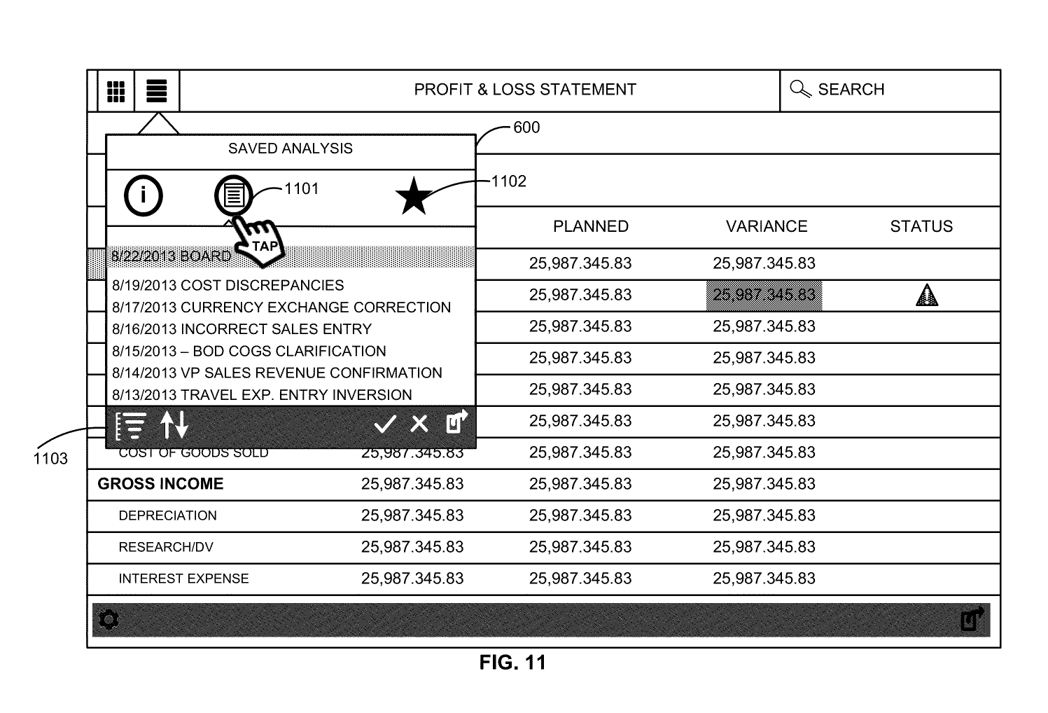

Referring to FIG. 11, in an embodiment, the user can view previously saved threads. The user selects (tap on) ‘saved threads’ icon 1101 (FIG. 11) of the threadanalyzer popover 600 to display all the saved threads. In an embodiment, one or more of the saved threads can be marked as a favorite. In an embodiment, a ‘star’ icon button 1102 may be selected to mark a currently selected thread as a ‘favorite.’ A tool bar 1103 may be provided at the bottom of the saved threads view of the threadanalyzer popover 600 to provide various global functions such as deleting a thread, renaming a thread, sending a thread, and additionally sorting, filtering and searching threads, etc. In an embodiment, a GUI element may be provided at the top of the popover 600 to switch between the threadanalyzer and the “saved threads” views.

In an embodiment, a mobile device installing the threadanalyzer may include accelerometer sensor which can be used to navigate between the thread UIs or the saved threads views. For example, referring to the threadanalyzer popover 600, the user can move the mobile device to “flip” between thread UIs to make mental assessments and analysis of financial data (numbers). In an embodiment, this may be accomplished by opening the threadanalyzer popover (e.g., the threadanalyzer popover 600) then tapping or clicking on a particular thread UI location. Even though only 2 Clicks, these are conceivably many “actions” (taps or clicks) to repeatedly switch between views, or forward/reverse between the views in a threadanalyzer string. Embodiments utilize various sensor means available on the mobile devices to cause navigation between the views within a thread string, or individually saved threads, so that the user's hands are completely available to hold the mobile device during such view navigations. The user need only to rapidly “rock” the mobile device from level to a left tilted orientation and back-to-level again to “back-up” through the thread UI views within a string of thread UI views, or the saved threads list to more directly recall and display corresponding document and dimensional views, without the need for their hands to ever leave holding the mobile device. The reverse action is also supported, rapidly “rocking” the mobile device from level to a right tilted orientation and back-to-level again will forward through each thread UI view within a thread string, or the saved threads in the saved threads list.

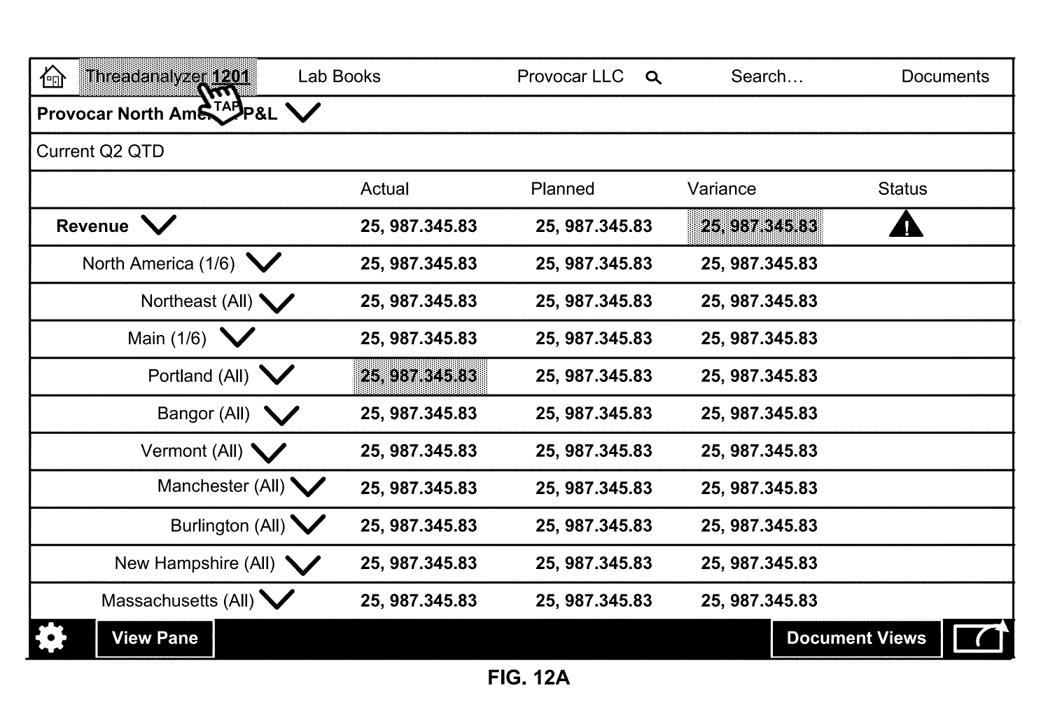

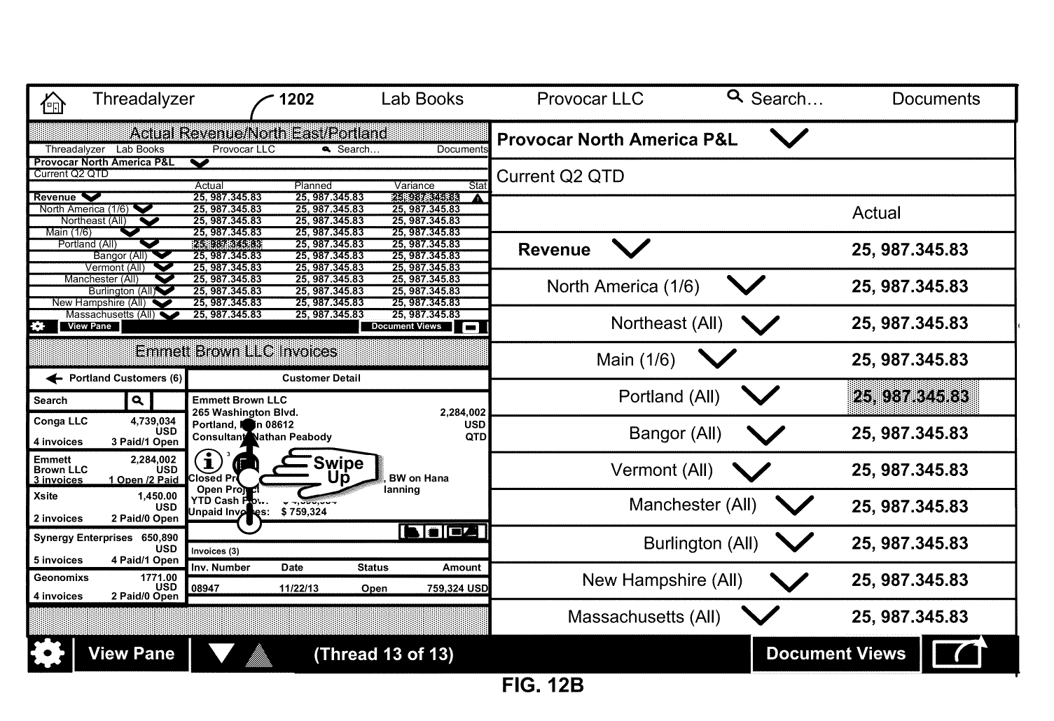

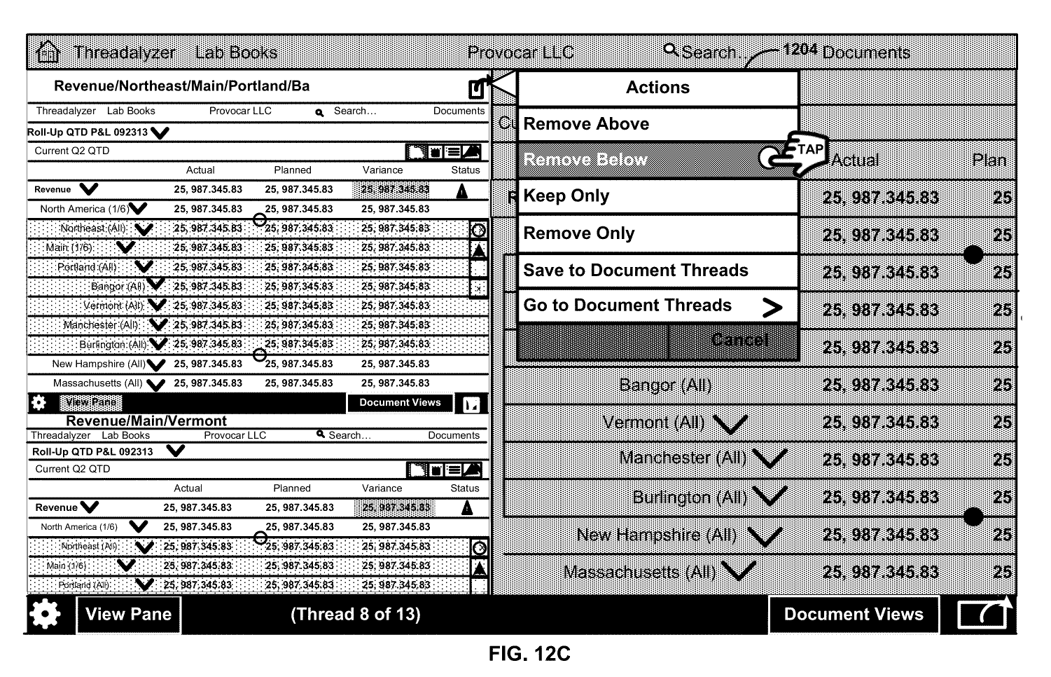

FIG. 12A-FIG. 12C illustrate opening the threadanalyzer to display a thread in a tile pane, according to an embodiment. FIG. 12A shows a threadanalyzer icon 1201 provided for opening the threadanalyzer. Upon selection of the threadanalyzer icon 1201, last thread including various views or captured screen are presented in a tile pane 1202 (FIG. 12B). The user can swipe up/down in the tile pane 1202 to view tiles that may be hidden or not visible on the screen. In an embodiment, the user can tap on a document tile to view the document (document view) or tap on the document action menu icon displayed in the currently viewed tile pane 1202 to open an action menu 1204 (FIG. 12C).

The action menu 1204 includes options like ‘remove above’ to remove document views above the selected document view in the thread, ‘remove below’ to remove document views below the selected document view in the thread, ‘keep only’ to keep just the selected document view, ‘remove only’ to just remove the selected document view, ‘go to document threads’ to view the saved document threads, and ‘save to document threads’ to save the current thread in stored document threads. In an embodiment, when the ‘save thread’ option is selected a pop-up (not shown) is displayed to enter name for saving the thread and then the thread gets saved as the entered name. In an embodiment, the action menu 1204 may also include options like ‘email thread slideshow (e.g., as a pdf),’ share on collaborative platform (e.g., as a pdf)′, ‘email thread (e.g., as a document link)’, ‘save all to my threads’, ‘go to my threads’, etc. The appropriate option can be selected and action is performed accordingly. For example, when ‘go to my threads’ option is selected, all threads included within my threads will be displayed and when ‘email thread slideshow’ is selected, an email UI is displayed enclosing the thread as slideshow attachment and addressing the consultant to whom email is to be sent.

Multi-dimensional view patterns vary depending on individual thought process during investigations. This explorative process is the multi-level hierarchical arrangement comprised of drill-downs into further detail and back up again, often moving laterally to explore an alternate drill-down paths. Moving laterally typically results from the user's determination that a particular thread drill-down investigation was futile and thus abandoned. During an active session, a lateral move automatically removes the view thread below the point at which the “lateral” change of investigation direction was made. The threadanalyzer also persistently recalls an existing thread. Therefore, if the user makes a lateral move to explore an alternate drill-down path, and later returns to the point at which the lateral move was made, re-instating the view parameter that was previously selected, the original thread is again recalled and made available in the threadanalyzer UI.

In an embodiment, a multi-dimensional view can be created using a dynamic multi-select hierarchical tree selection. The dynamic multi-select hierarchical tree control UI provides the ability for a user to drill-down into multiple category hierarchies at varying levels and make one or more selections that would be displayed in the financial data table (e.g., P&L Statement). The dynamic multi-select hierarchical tree control provides an optimized “user-relevant view” that limits the tree display to show only what is in context to user navigation selections and actions. Auto-adjust animation behaviors deliver an optimized and “relevant” screen view of hierarchical tree list structures. The “dynamic” characteristic provides a solution that automatically and dynamically re-displays tree levels through animations as the user makes selections or scrolls the tree-list. The animation sequence is also the system component that display's “relevant” hierarchies as the user actually makes selections and navigations when drilling down or up during unstructured investigations. With each dynamic multi-select hierarchical tree control user selection, the threads views are automatically recorded by the threadanalyzer.

In an embodiment, a multi-dimensional view can be created using a non-dynamic multi-select hierarchical control. Multi-selection of dimensional view hierarchical categories is accomplished using the standard single-screen pattern and control. The user does not have the contextual affordances of the dynamic multi-select hierarchical tree control to refer where they came from and where they have navigated to on the same UI. The next category from a prior selection may be viewed, however the tree hierarchy is not displayed in this approach.

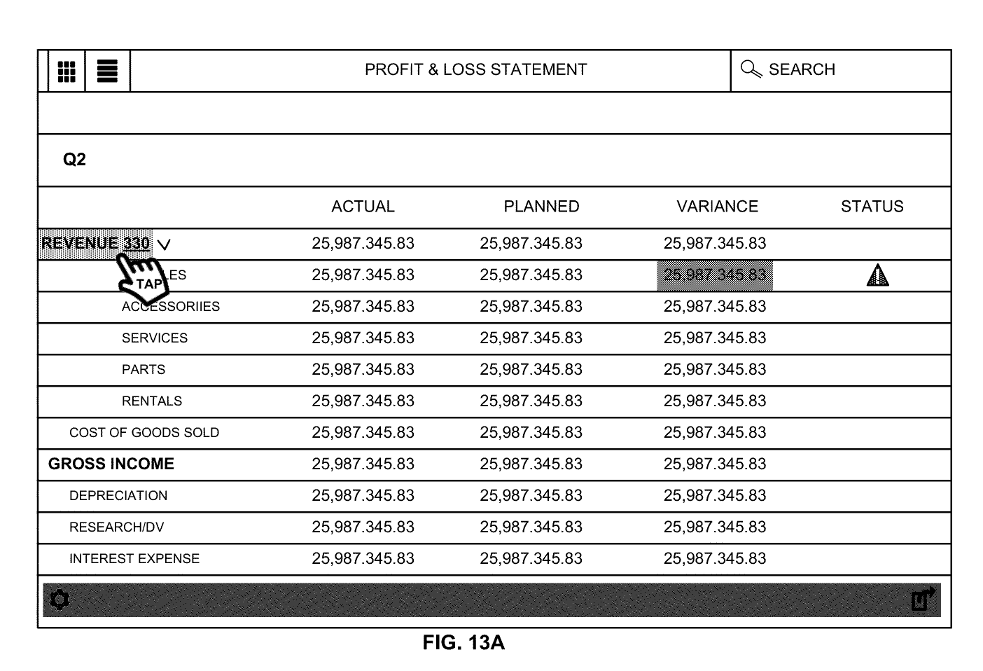

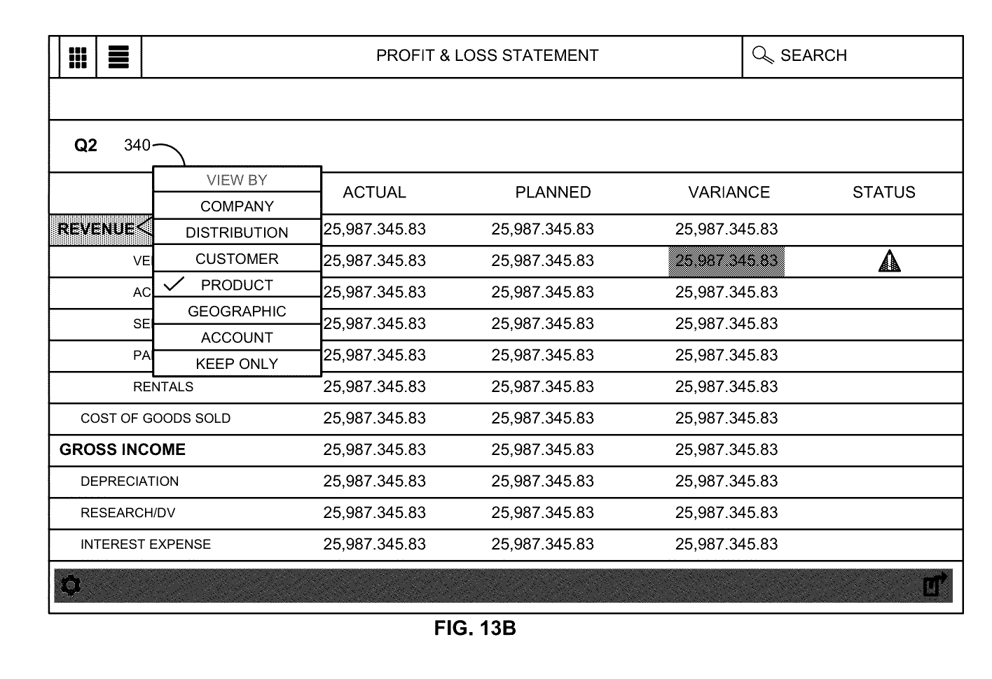

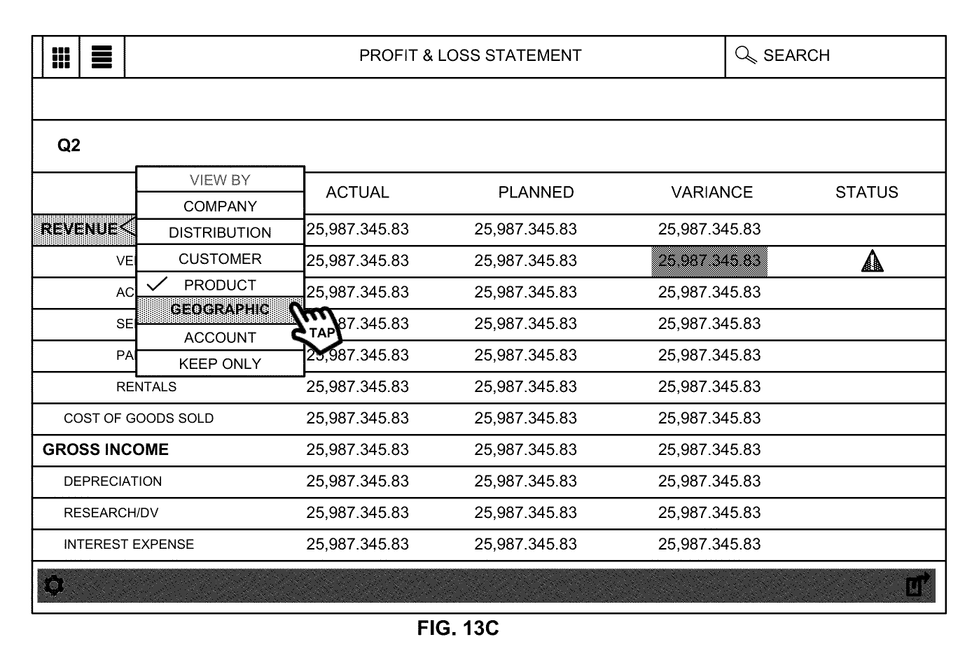

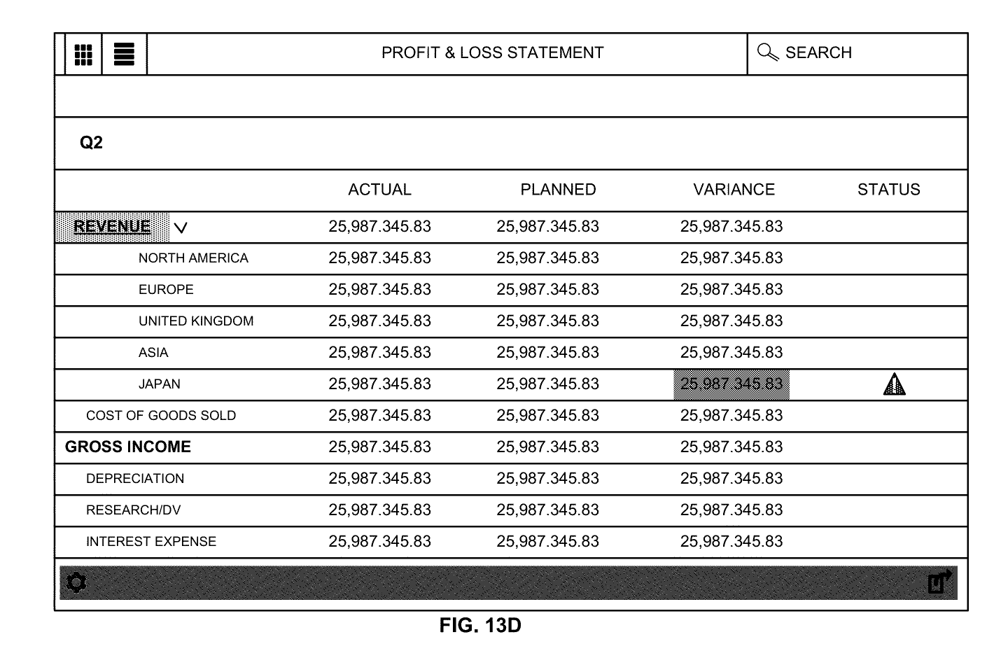

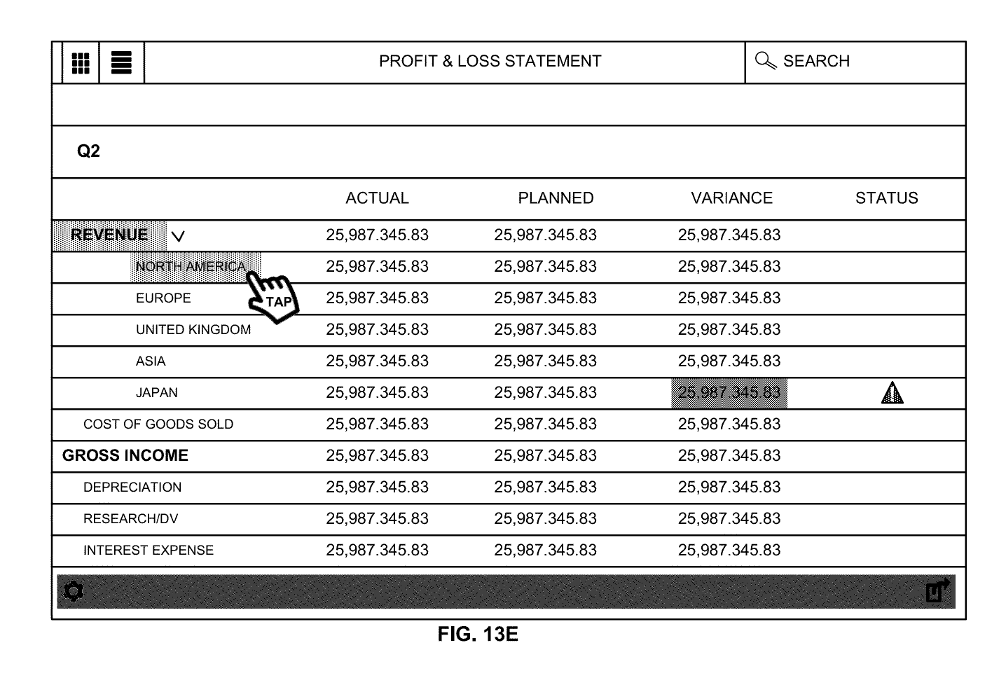

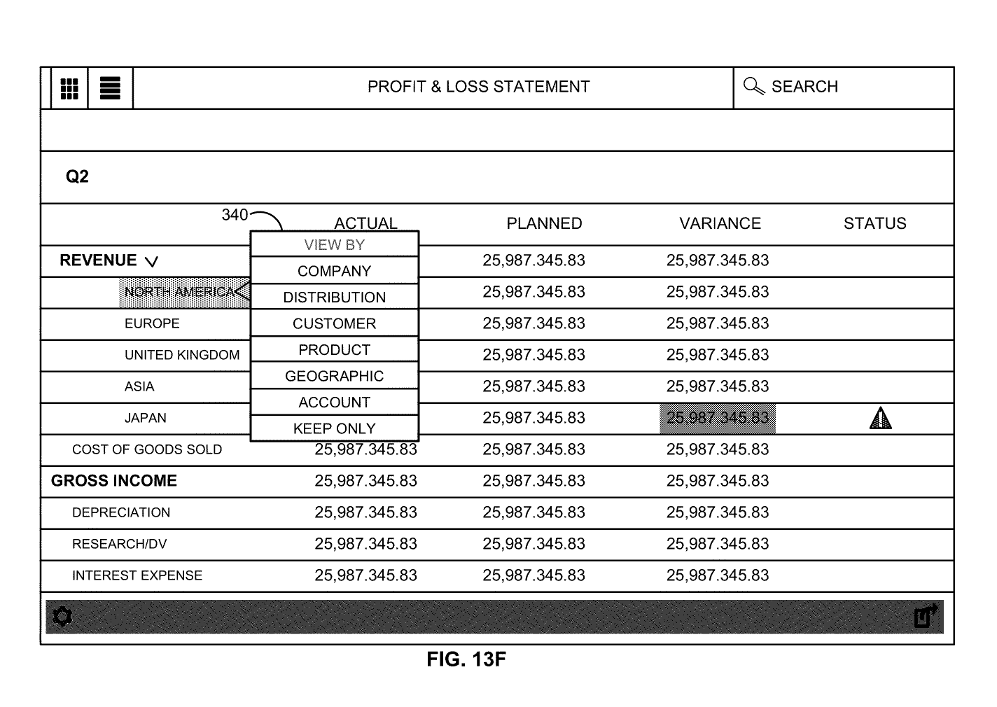

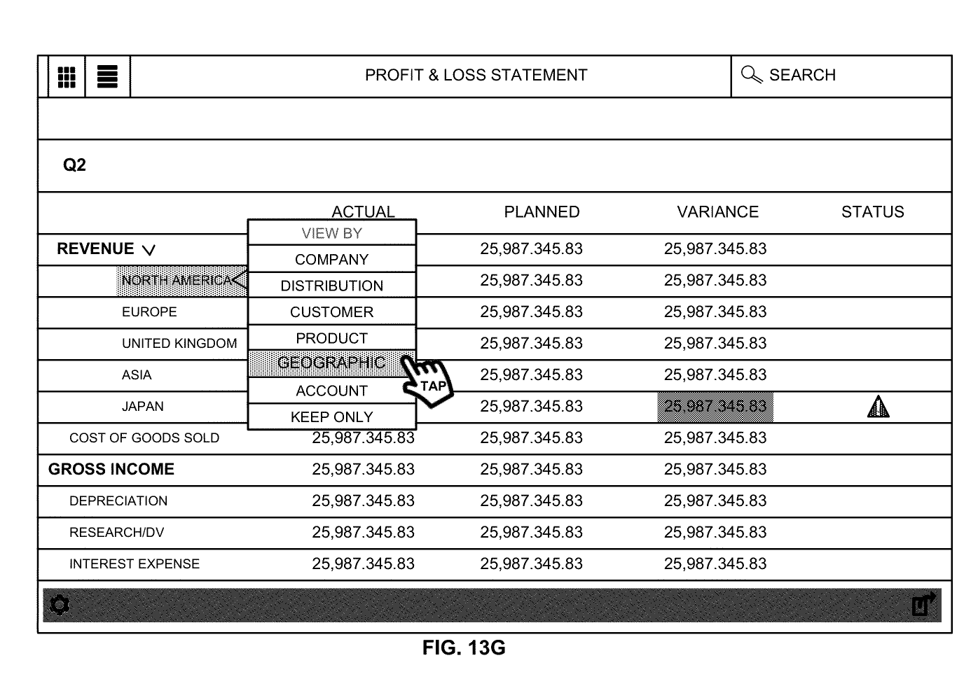

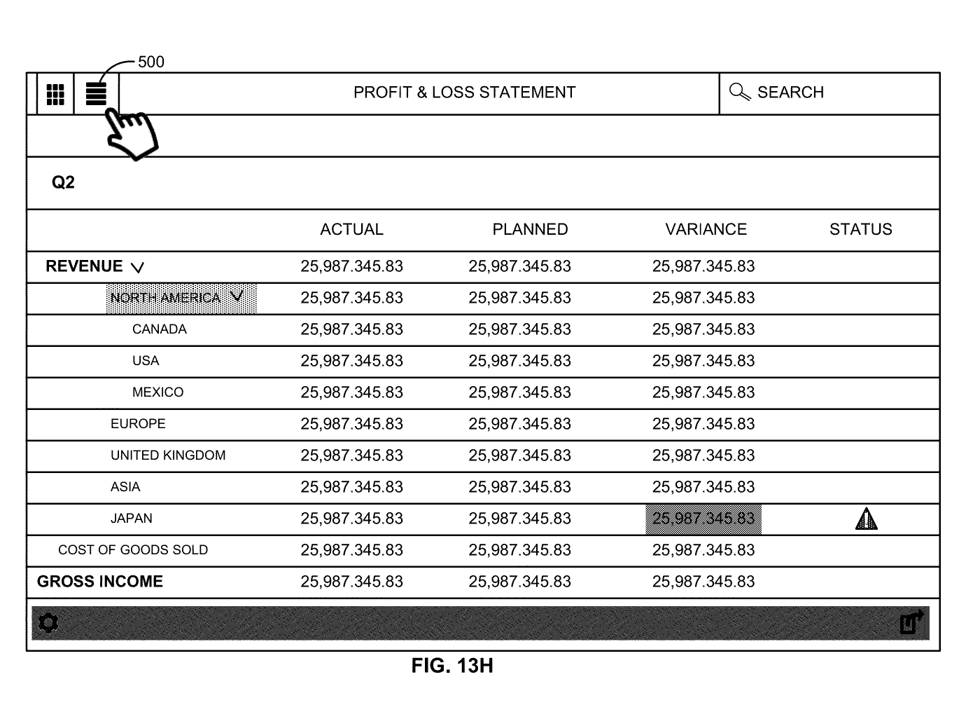

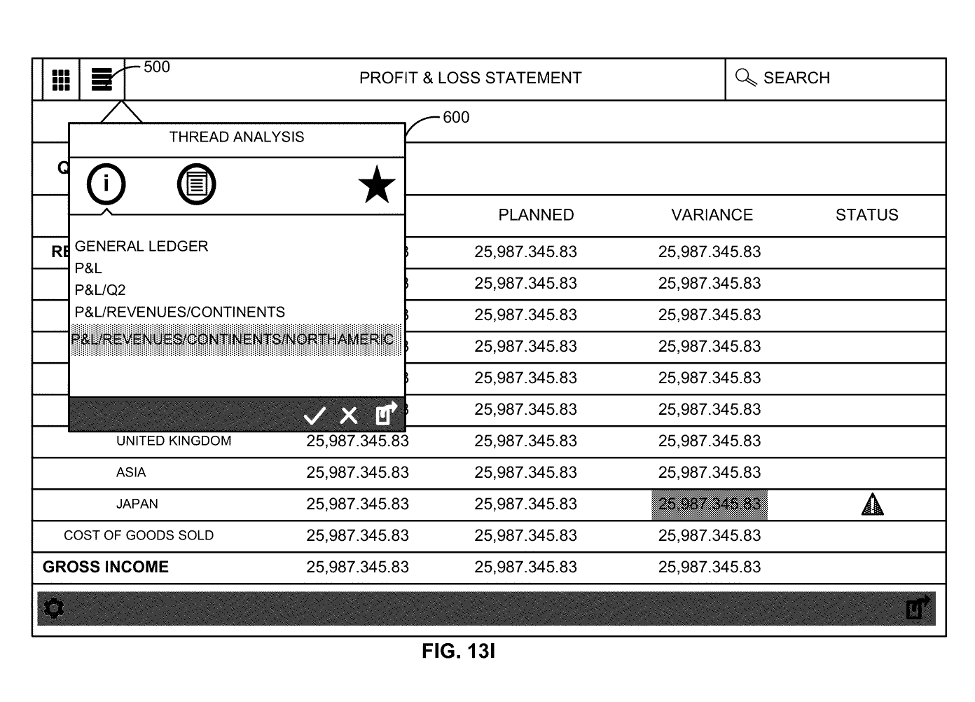

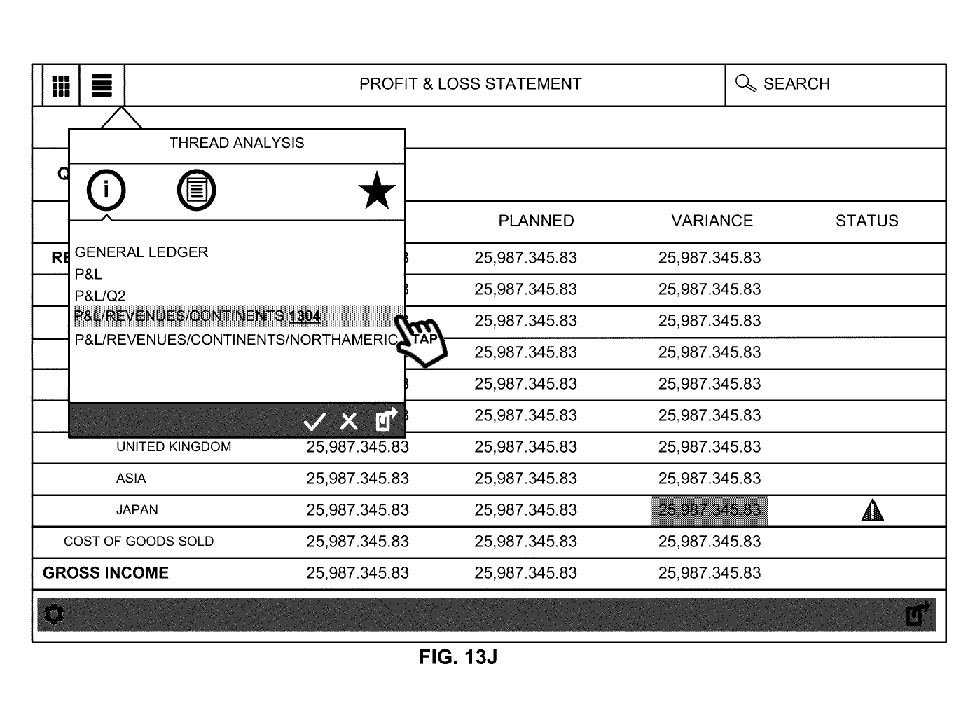

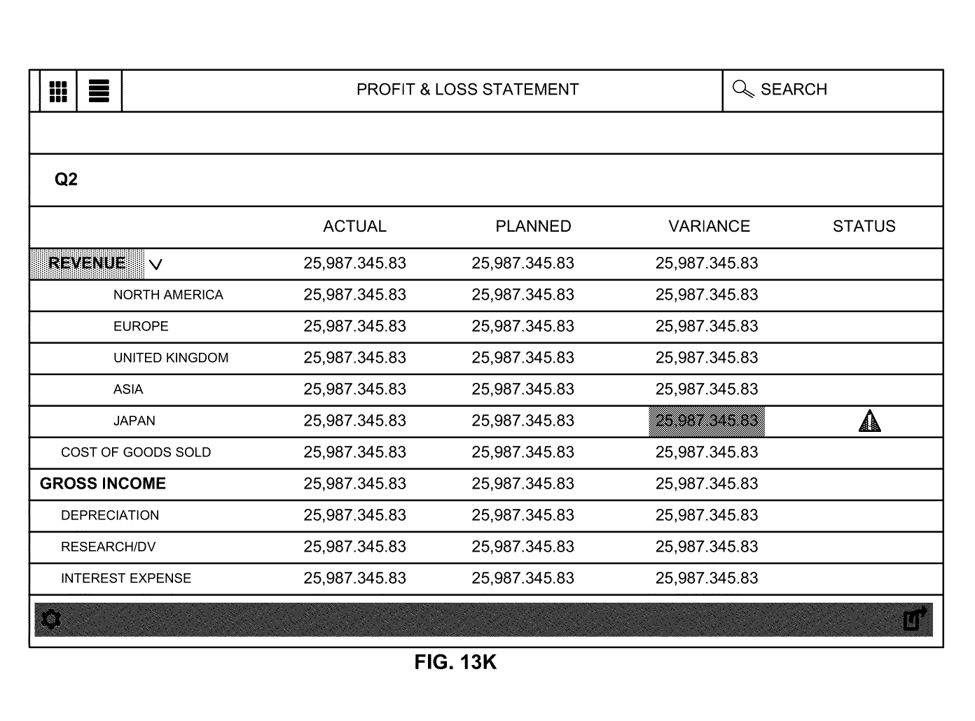

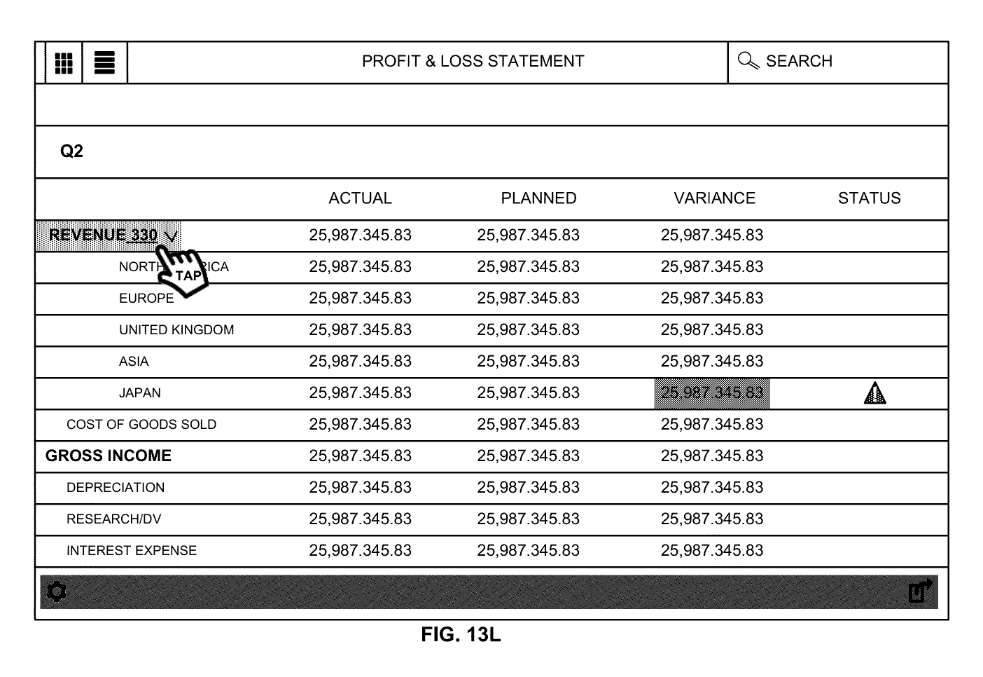

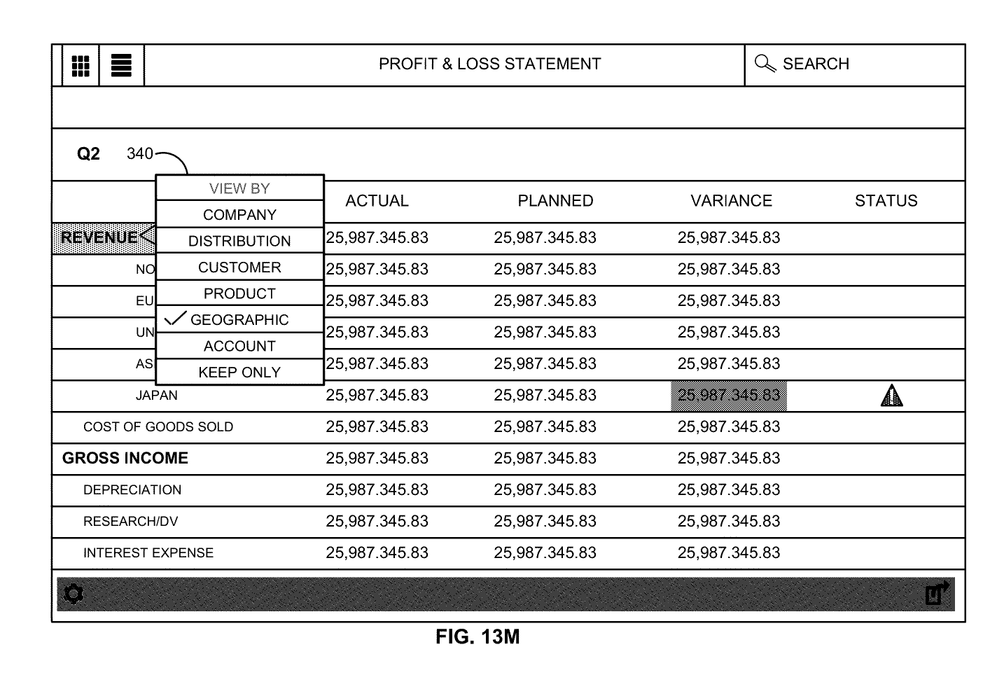

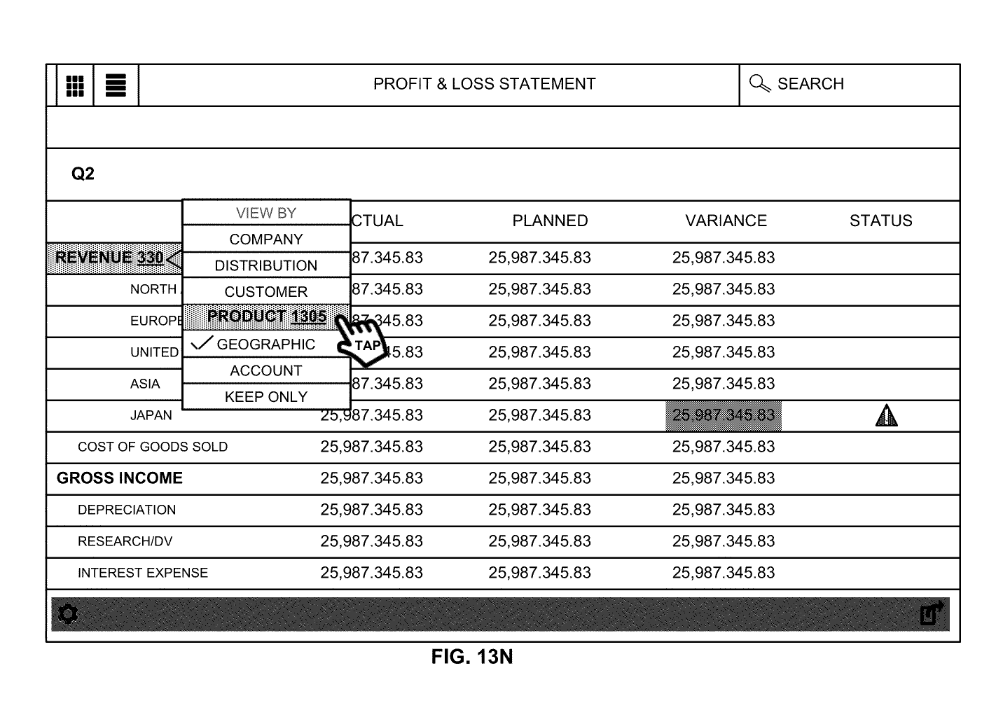

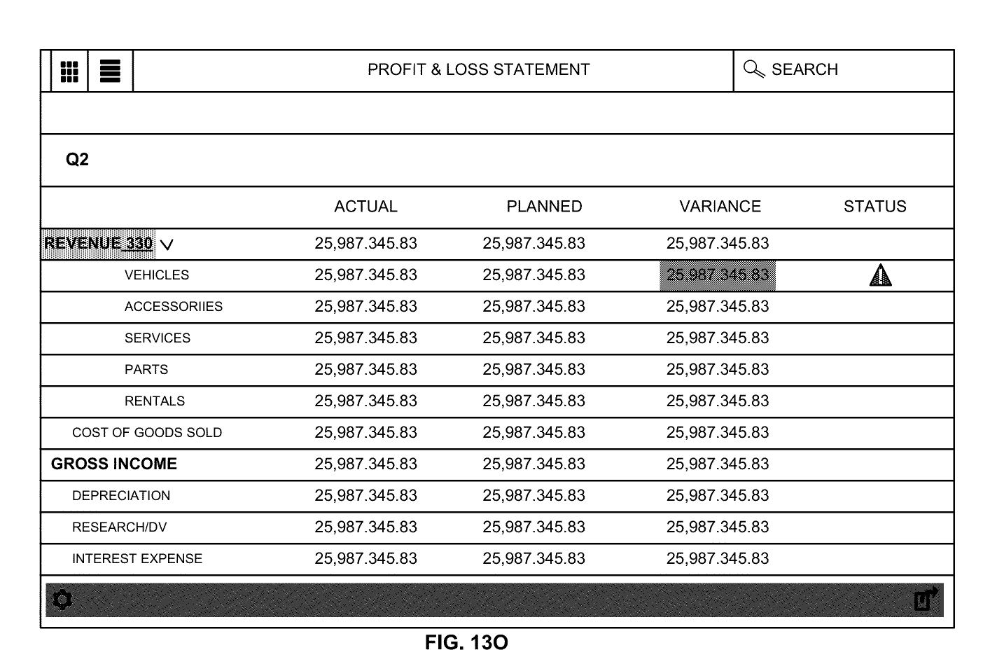

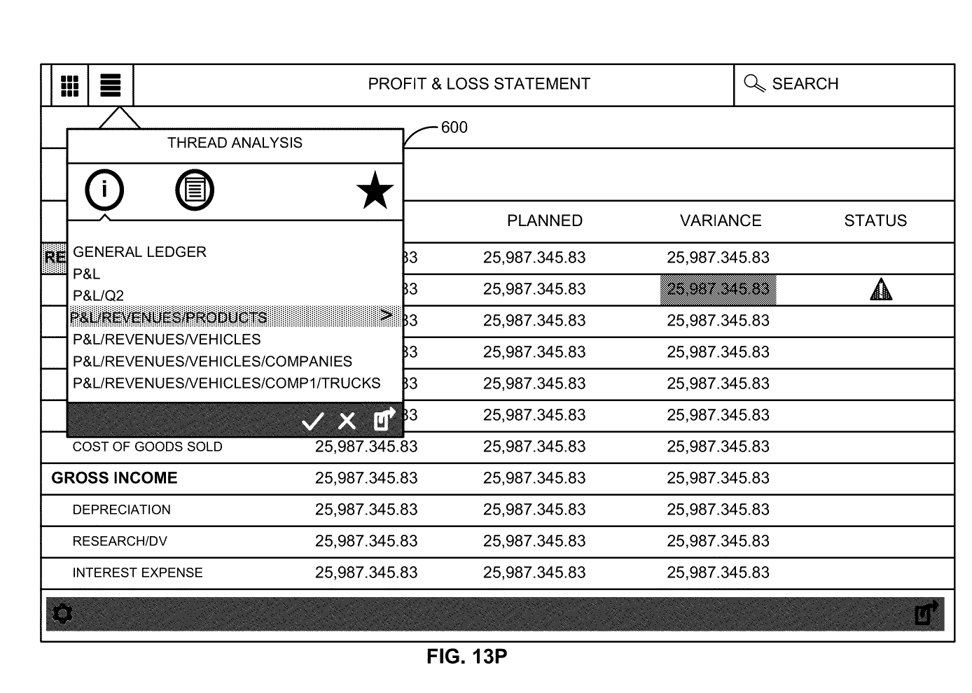

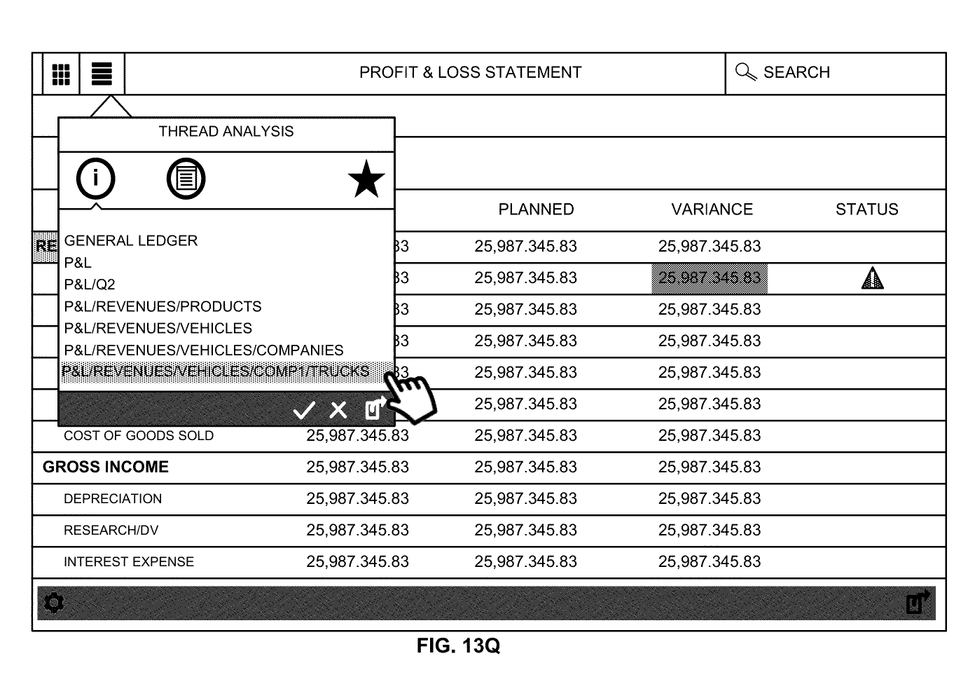

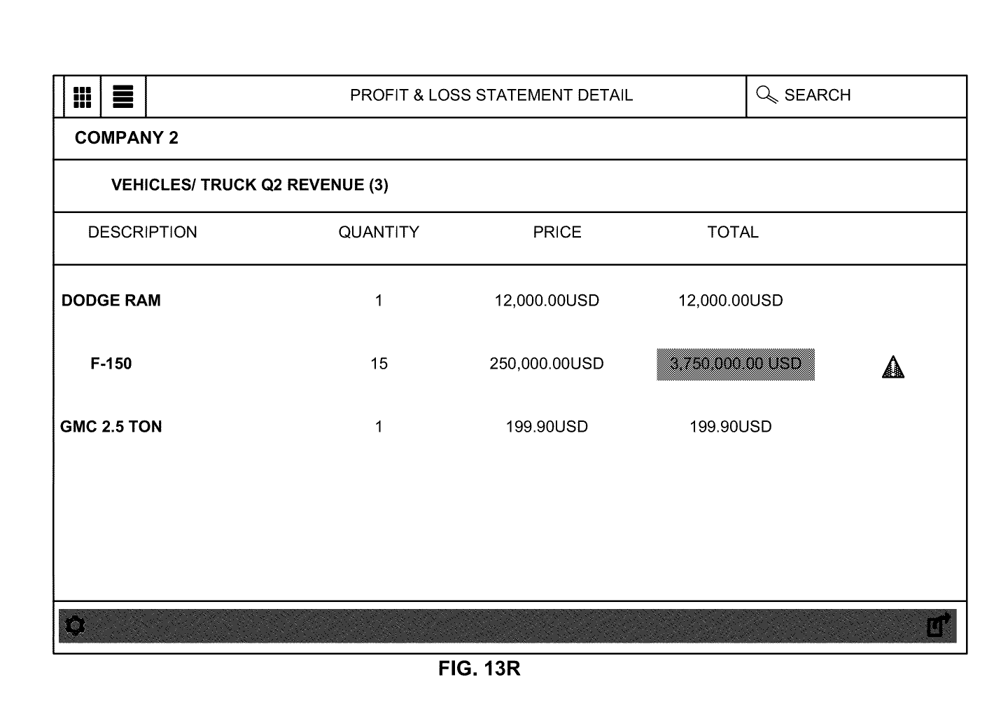

In an embodiment, after closing the threadanalyzer popover 600, the view corresponding to the last selection is displayed (FIG. 13A). When the user selects the revenue to open the “view by” menu 340 (FIG. 13B) for a specific cell. The previously selected cell-specific “view by” menu 340 is displayed with the check marked selection indicating the previous selection (FIG. 13B). FIG. 13C shows the user returns and decides to make a “lateral move” change, and select revenues to be viewed by geographic parameters. FIG. 13D shows that the multi-dimensional financial view now been changed to revenues by geography. FIG. 13E-FIG. 13F show the user selects “North America” and again open the ‘view by’ menu 340 for “North America”. In FIG. 13G, the user selects the geographical parameter for “North America” from the ‘view by’ menu 340. Based upon selection in FIG. 13G, FIG. 13H is displayed. In FIG. 13H, top level geographies for North America are displayed. In an embodiment, the user may decide to abandon this drill-down and opens the threadanalyzer. FIG. 13I illustrates the thread analysis button 500 which can be selected to open the threadanalyzer popover 600, as shown in FIG. 13I. FIG. 13J illustrates that the user selects revenue by continent view, i.e., P&L/revenues/continents 1304 (entry point of lateral move). Based upon the user selection, FIG. 13K is rendered wherein the financial data returns to the revenue by continents view.

In one embodiment, the user reviews and analyzes these numbers and might get convinced that this investigation is futile. Therefore, the user again selects the revenue 330 to open the menu options, as shown in FIG. 13L. In FIG. 13M, the menu ‘view by’ 340 is displayed indicating the last item selection. FIG. 13N shows that the user selects “by product” view option 1305 for revenues as was previously selected in the prior thread. Based upon the selection, FIG. 13O is displayed wherein the financial data display returns to the identical view from the prior thread. The user may decide to again investigate this previous thread, as “by geography” investigations did not produce any results or clues to the problem. Therefore, the user again opens the threadanalyzer popover 600, as shown in FIG. 13P. The user can refer the views from the previous thread, and may decide to once again “jump-to” the document level. The user selects the document level view from the restated thread, as shown in FIG. 13Q. Based upon the selection, the user is returned to the document level (FIG. 13R) where the decision is confirmed about the problem. The user can then resolve the issues.

In an embodiment, the threadanalyzer 110 can be operated in a manual mode. In the manual mode, the user selects the screen captures or UIs to be included within the thread. The selected UIs are included within the thread according to hierarchy in which the screen is captured by the user.

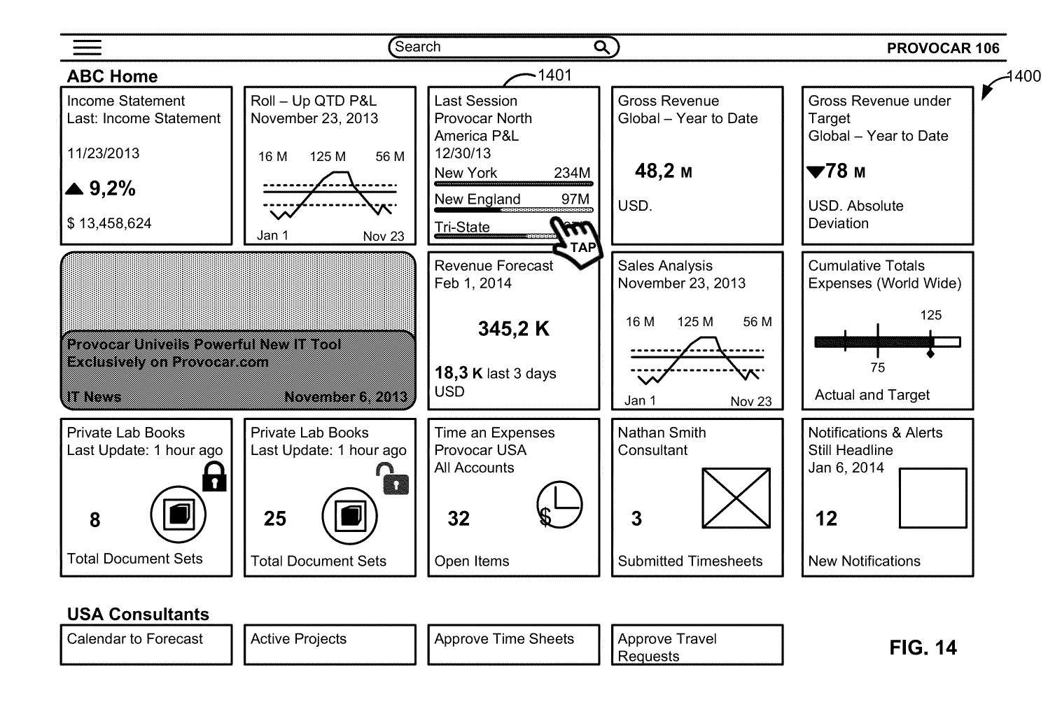

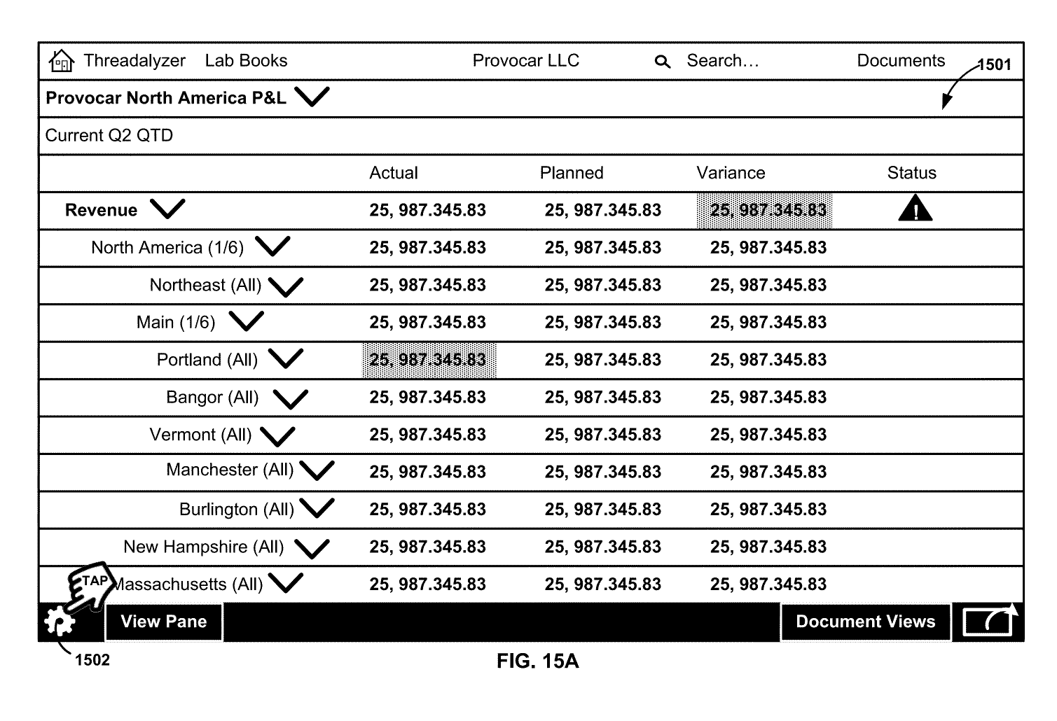

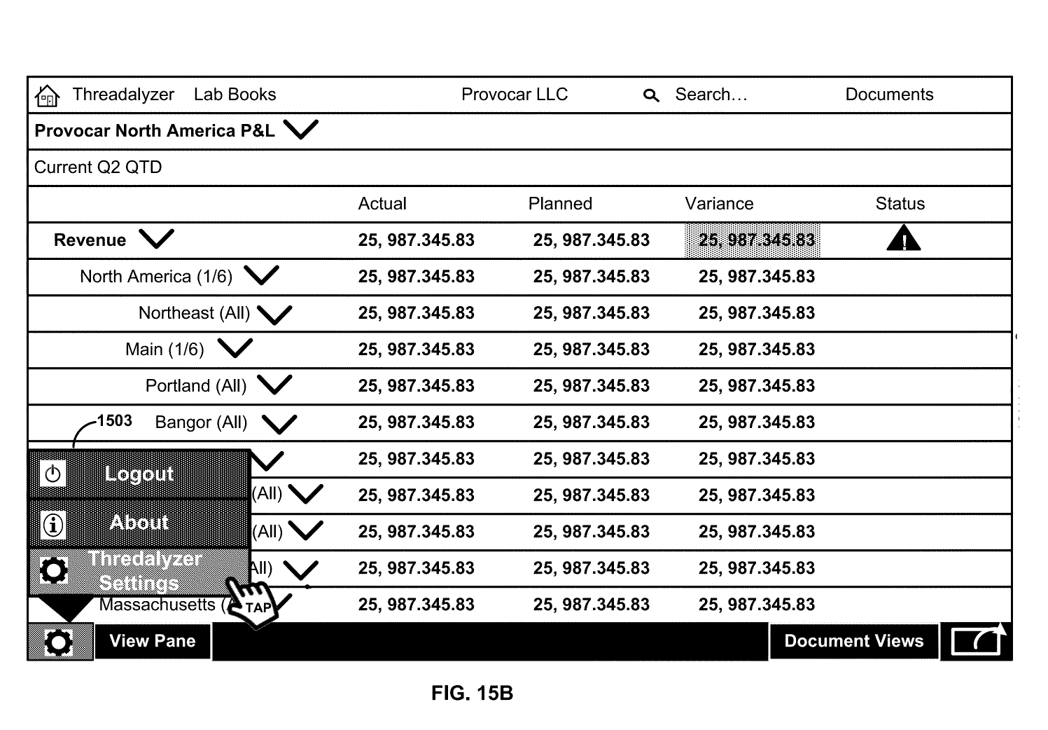

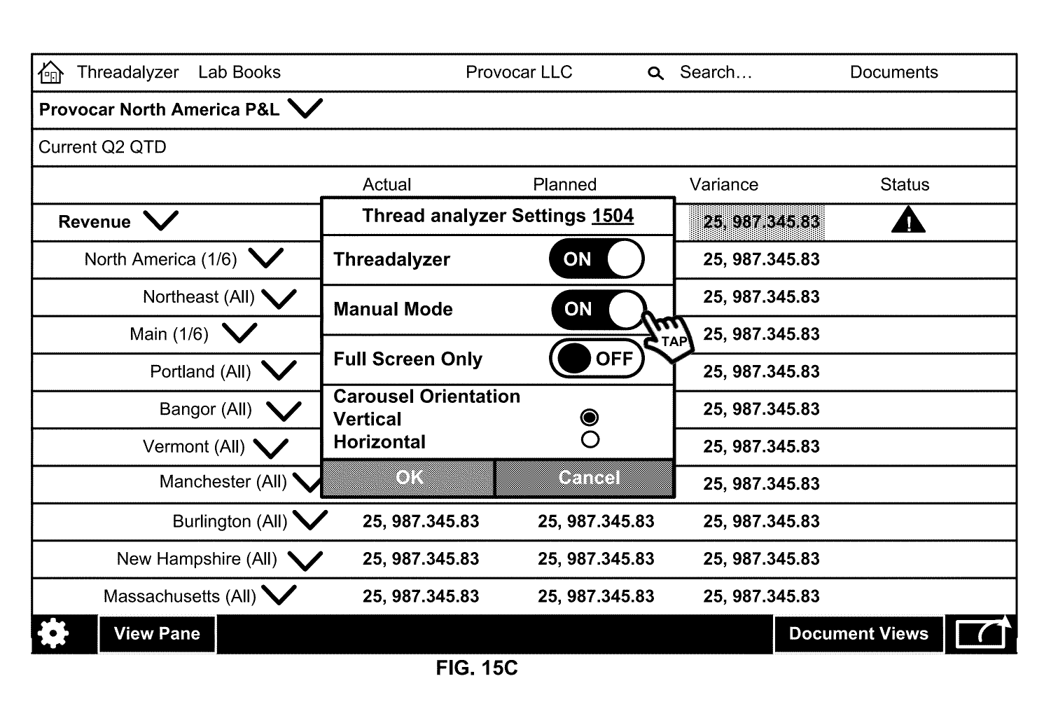

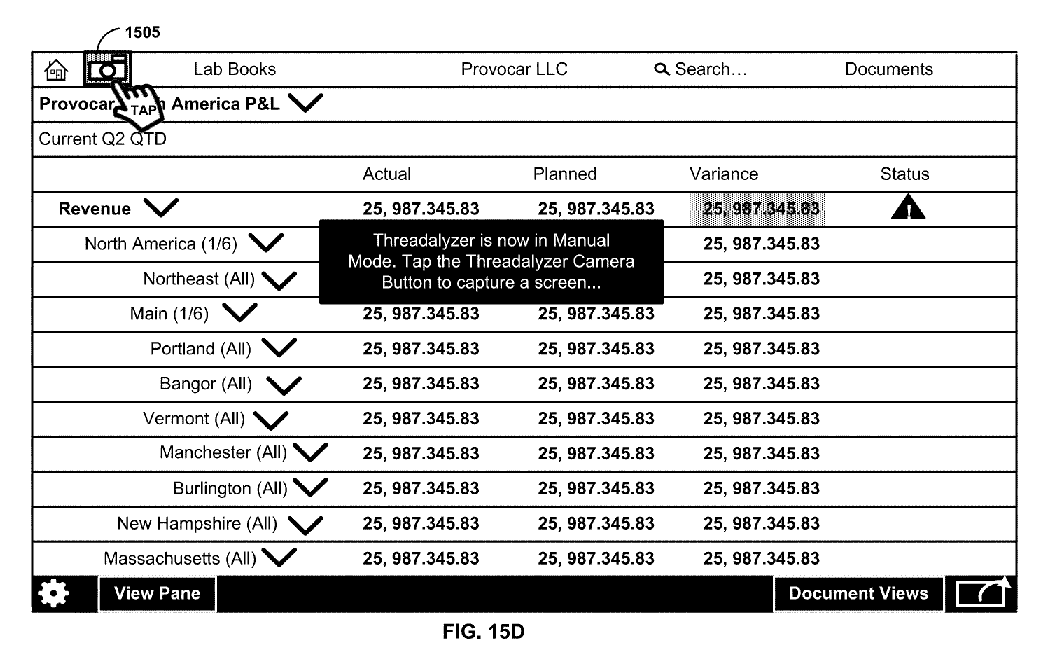

Referring to FIG. 14, the user (ABC) home page 1400 is displayed. The user may select last session Provocar North America P&L′ 1401 tile to view the Trovocar North America P&L′ report. Upon selection of the Provocar North America P&L′, a report or UI 1501 (FIG. 15A) is displayed. The user may tap on an icon 1502. Upon selection or tapping on the icon 1502, a pop-up 1503 (FIG. 15B) is displayed. The pop-up 1503 includes options for “threadanalyzer settings”. The user can tap on the “threadanalyzer settings” for editing default settings of the threadanalyzer. Once the “threadanalyzer settings” is tapped, a threadanalyzer settings menu 1504 (FIG. 15C) is displayed. The threadanalyzer settings menu 1504 includes option for switching ON/OFF the threadanalyzer, switching the threadanalyzer in a manual mode, showing the threadanalyzer UI in full screen, and showing a tile pane window (threadanalyzer carousel) for displaying threads within the tile pane in a vertical or a horizontal orientation.

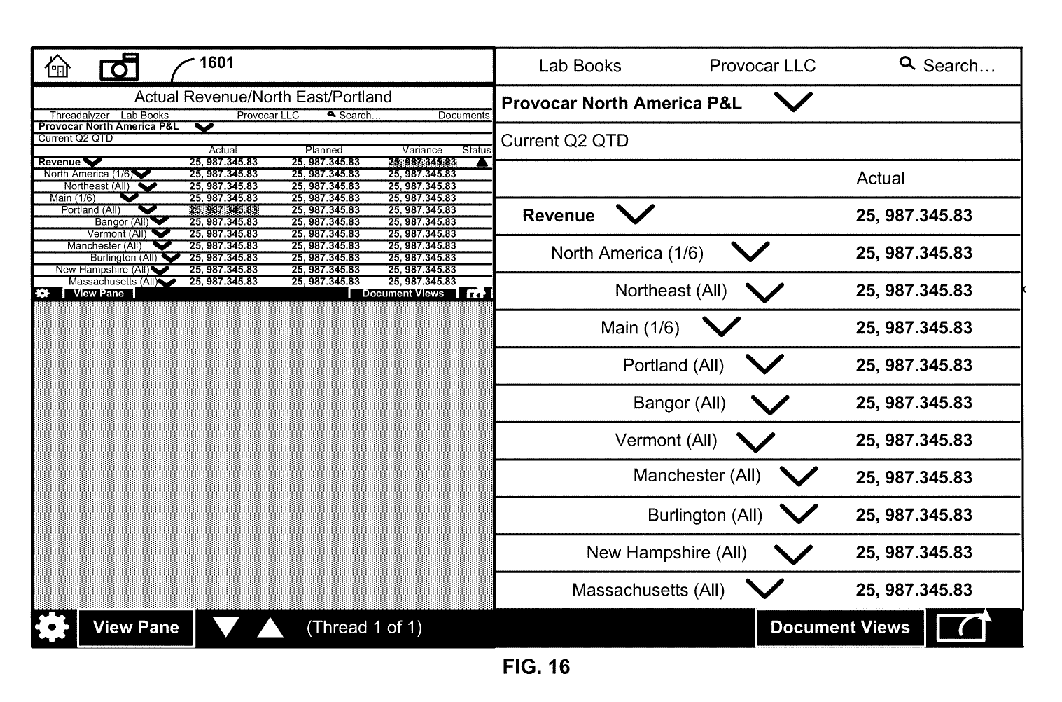

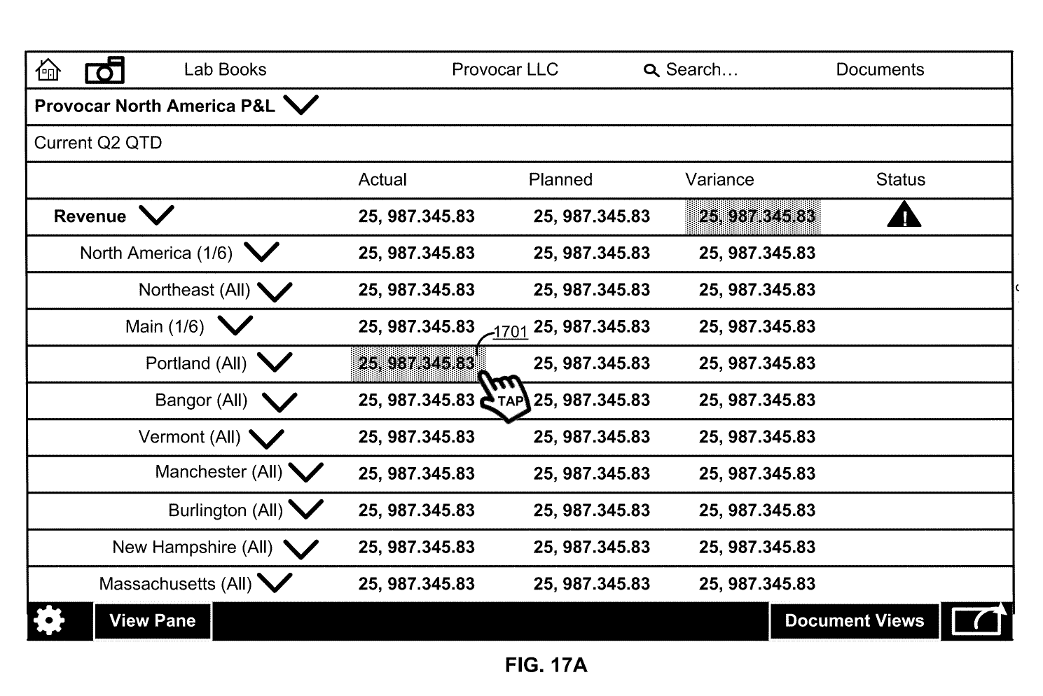

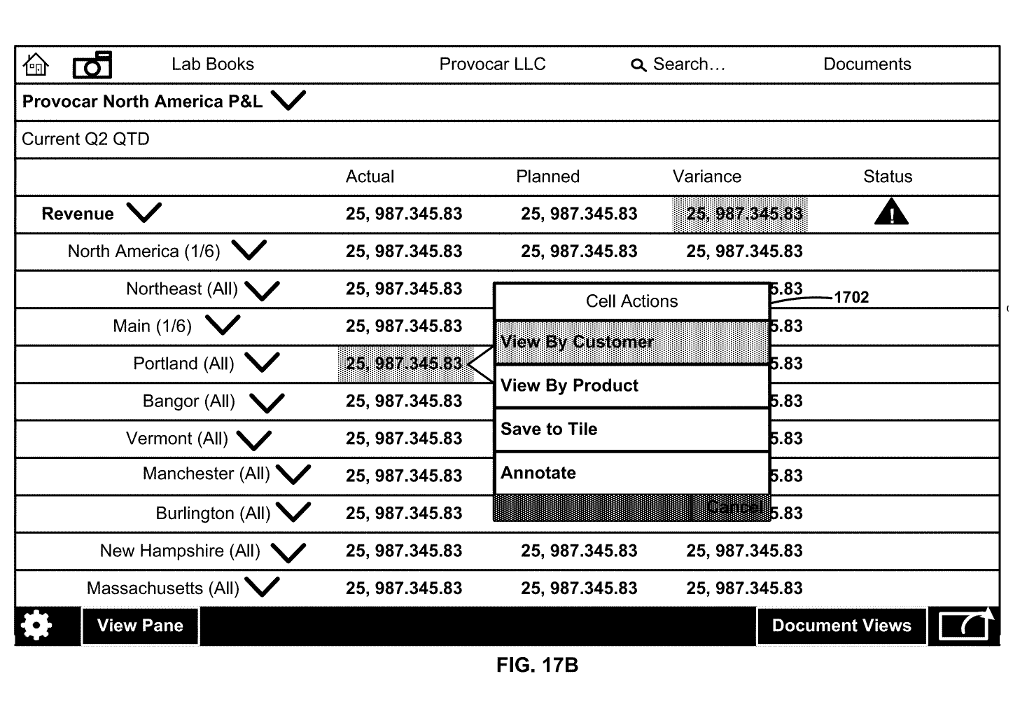

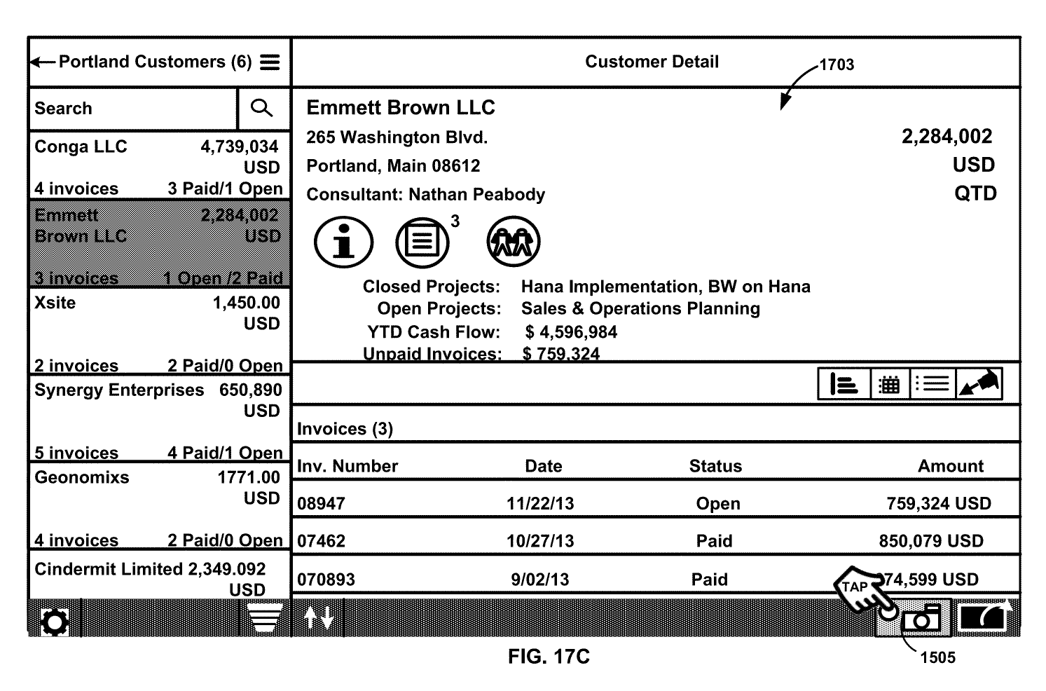

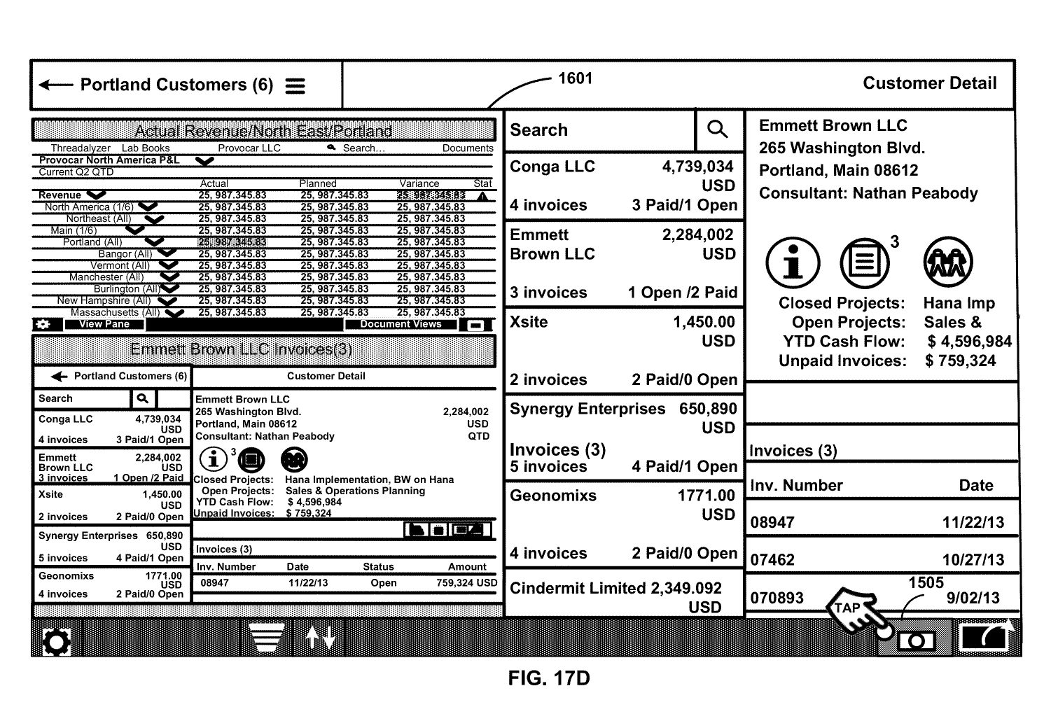

Once the ‘manual mode’ option is selected ON from the threadanalyzer settings menu 1504, the ‘threadanalyzer’ tab on the UI gets converted to a graphic, e.g., ‘camera’ 1505 (FIG. 15D) to indicate that manual mode is selected ‘ON.’ Using the camera or tapping on the camera, the user can capture the screen or UI. The captured screen gets included or reflected in a tile pane 1601 (FIG. 16). For example, the screen UI Actual Revenue/North East/Portland is reflected in the threadanalyzer tile pane 1601. Now, suppose the user taps on a data 1701 as shown in FIG. 17A to open cell action menu 1702 (FIG. 17B) to view the data by customer. The user selects the ‘view by customer’ option from the cell action menu 1702. Upon selection, an UI 1703 (FIG. 17C) is displayed. As shown, the threadanalyzer ‘camera’ 1505 is displayed at the bottom of the UI 1703. When the user taps on the ‘camera’ 1505, the screen UI 1703 is captured and included or reflected in the tile pane 1601 to indicate that the screen capture is included in the thread, as shown in FIG. 17D.

Therefore, user manually captured UIs or selected UIs within the thread make thread more concise and understandable. The customized analysis is captured so that it can indicate the specific area or data which is analyzed. As the analysis is more refined and directed, the threadanalyzer in manual mode speeds up the relevant analysis and can be used as a training tool. The user can directly and instantly send the customized thread related to an issue that they may notice.

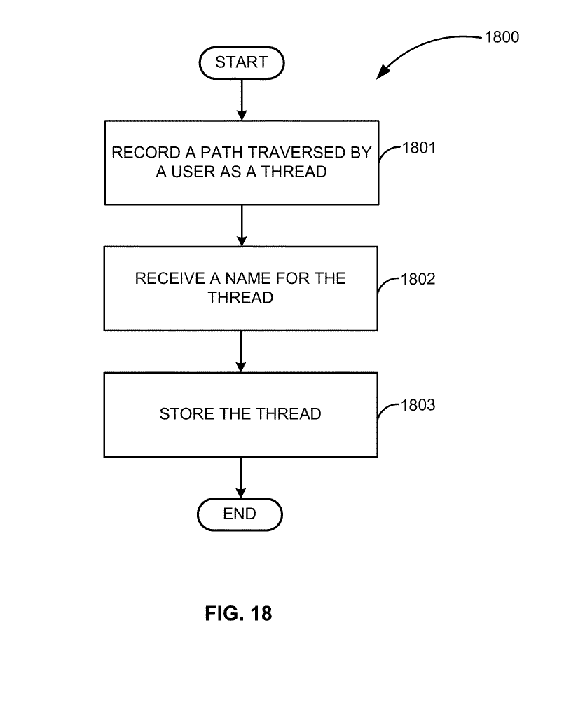

FIG. 18 is a flowchart illustrating process 1800 to capture user's navigations and explorations, according to an embodiment. At 1801, a path traversed by a user is recorded as a thread. In an embodiment, recording comprises at least one of tracking, identifying, and capturing. In an embodiment, while recording, if it is determined that the user traversed back on one or more sub-paths included within the path, one or more UIs corresponding to the one or more sub-paths are removed from the thread. Upon recording the path as a thread, an option is provided to the user for customizing the thread, e.g., providing name for the thread. At 1802, a name for the thread is received. Once the name is received, the thread is stored at 1803. In an embodiment, various operations may be performed on the stored thread including, but not limited to, renaming the thread, sharing the thread, removing some UIs from the thread, etc.

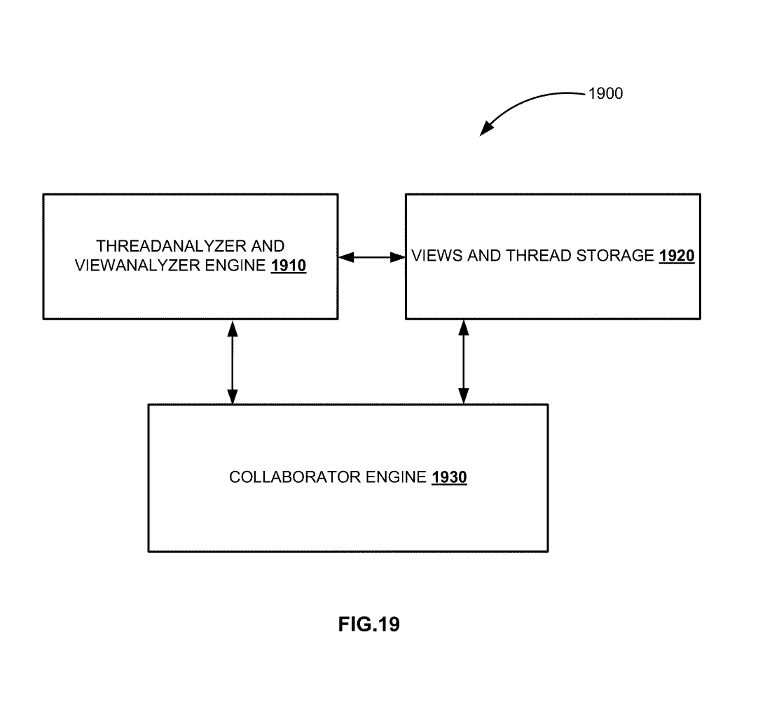

FIG. 19 is a block diagram of an exemplary backend 1900 for capturing, storing, and communicating the threads, according to an embodiment. The backend 1900 comprises a threadanalyzer and viewanalyzer engine 1910 communicatively coupled to views and thread storage 1920. The threadanalyzer and viewanalyzer engine 1910 tracks and captures user's navigations and selections. The user's navigations and selections may be saved as at least one of a thread and a view. The thread and/or view is saved in the views and thread storage 1920. The stored thread and/or view can be communicated to one or more recipients. The backend 1900 also includes a collaborator engine 1930. The collaborator engine 1930 processes and maintains all communications related to the stored views and threads. In an embodiment, the collaborator engine 1930 is communicatively coupled to at least one of the threadanalyzer and viewanalyzer engine 1910 and the views and thread storage 1920. In an embodiment, the collaborator engine 1930 may be a part of the threadanalyzer and viewanalyzer engine 1910.

Some embodiments may include the above-described methods being written as one or more software components. These components, and the associated functionalities, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

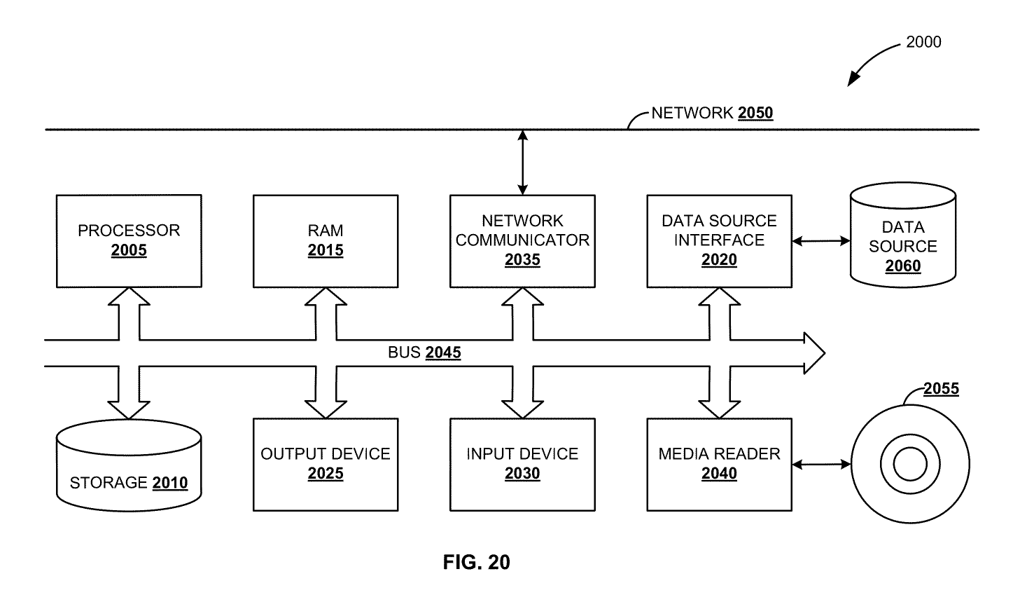

FIG. 20 is a block diagram of an exemplary computer system 2000. The computer system 2000 includes a processor 2005 that executes software instructions or code stored on a computer readable storage medium 2055 to perform the above-illustrated methods. The processor 2005 can include a plurality of cores. The computer system 2000 includes a media reader 2040 to read the instructions from the computer readable storage medium 2055 and store the instructions in storage 2010 or in random access memory (RAM) 2015. The storage 2010 provides a large space for keeping static data where at least some instructions could be stored for later execution. According to some embodiments, such as some in-memory computing system embodiments, the RAM 2015 can have sufficient storage capacity to store much of the data required for processing in the RAM 2015 instead of in the storage 2010. In some embodiments, all of the data required for processing may be stored in the RAM 2015. The stored instructions may be further compiled to generate other representations of the instructions and dynamically stored in the RAM 2015. The processor 2005 reads instructions from the RAM 2015 and performs actions as instructed. According to one embodiment, the computer system 2000 further includes an output device 2025 (e.g., a display) to provide at least some of the results of the execution as output including, but not limited to, visual information to users and an input device 2030 to provide a user or another device with means for entering data and/or otherwise interact with the computer system 2000. One or more of these output devices 2025 and input devices 2030 could be joined by one or more additional peripherals to further expand the capabilities of the computer system 2000. A network communicator 2035 may be provided to connect the computer system 2000 to a network 2050 and in turn to other devices connected to the network 2050 including other clients, servers, data stores, and interfaces, for instance. The modules of the computer system 2000 are interconnected via a bus 2045. Computer system 2000 includes a data source interface 2020 to access data source 2060. The data source 2060 can be accessed via one or more abstraction layers implemented in hardware or software. For example, the data source 2060 may be accessed by network 2050. In some embodiments the data source 2060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer readable medium to tangibly store instructions, which when executed by a computer, cause the computer to perform operations comprising:
record a path traversed by a user as a thread, wherein the path is traversed within at least one document and wherein the thread includes one or more user interfaces (UIs) arranged in a hierarchical topology;
customize the thread based on at least one of: naming the thread and removing at least one UI from the one or more UIs included in the thread; and
store the customized thread.

2. The non-transitory computer readable medium of claim 1, wherein the path traversed by the user comprises user-exploration in a multi-dimensional view format.

3. The non-transitory computer readable medium of claim 1, wherein the document comprises a financial document including one of a general ledger, an income statement, and profit and loss statement.

4. The non-transitory computer readable medium of claim 1, wherein recording comprises at least one of identifying, tracking, and capturing.

5. The non-transitory computer readable medium of claim 1, wherein the thread is stored as at least one of:
a link comprising an address of an entry point of the thread; and
an image file comprising images of the one or more user interfaces included within the thread.

6. The non-transitory computer readable medium of claim 5, wherein at least one of the one or more UIs within the thread includes an option to display data in at least one of a real time and time when the at least one of the one or more UIs is recorded.

7. The non-transitory computer readable medium of claim 5 comprising instructions, which when executed by the computer, cause the computer to perform operations further comprising:
receive a command for sending the stored thread to one or more recipients;
based upon the command, display an option for enclosing the thread as at least one of the link and the image file;
based upon the user selection of the option, enclose the thread in an email; and
upon receiving a user's instruction, send the email to the one or more recipients.

8. The non-transitory computer readable medium of claim 1 comprising instructions, which when executed by the computer, cause the computer to perform operations further comprising:
upon receiving a command for displaying the stored thread, display the stored thread;
upon receiving a command for displaying the one or more stored thread UIs in a tile pane, displaying the stored one or more thread UIs in the tile pane; and
upon receiving a command relative to a selected thread UI in the tile pane, perform at least one of:
delete the selected thread UI;
share the selected thread UI with one or more recipients;
remove one or more thread UIs above the selected thread in the tile pane;
remove one or more thread UIs below the selected thread UI in the tile pane; and
keep only the selected thread UI in the tile pane.

9. The non-transitory computer readable medium of claim 1 comprising instructions, which when executed by the computer, cause the computer to perform operations further comprising:
upon determining the user traversed back on one or more sub-paths included within the path, remove or restore one or more UIs corresponding to the one or more sub-paths from the thread.

10. A computer-implemented method for capturing user's navigation and exploration, the method comprising:
recording a path traversed by a user as a thread, wherein the path is traversed within at least one document and wherein the thread includes one or more user interfaces (UIs) arranged in a hierarchical topology;
customizing the thread based on at least one of: naming the thread and removing at least one UI from the one or more UIs included in the thread; and
storing the customized thread.

11. The computer-implemented method of claim 10, further comprising:
upon determining the user traversed back on one or more sub-paths included within the path, removing or restoring one or more UIs corresponding to the one or more sub-paths from the thread.

12. A system for capturing user's navigations and explorations comprising:
a threadanalyzer configured to:
record a path traversed by a user as a thread, wherein the path is traversed within at least one document and wherein the thread includes one or more user interfaces (UIs) arranged in a hierarchical topology;
customize the thread based on at least one of: naming the thread and removing at least one UI from the one or more UIs included in the thread; and
store the customized thread; and
a collaborator communicatively coupled to the threadanalyzer to communicate at least one of the one or more stored threads and an information related to the at least one of the one or more stored threads to one or more recipients.

13. The system of claim 12, wherein the thread is stored as at least one of:
a link comprising an address of an entry point of the thread; and
an image file comprising images of the one or more user interfaces included within the thread.

14. The system of claim 13, wherein at least one of the one or more UIs within the thread includes an option to display data in at least one of a real time and time when the at least one of the one or more UIs is recorded.

15. The system of claim 12, wherein the threadanalyzer is further configured to:
upon receiving a command for displaying the stored thread, display the stored thread;
upon receiving a command for displaying the one or more stored thread UIs in a tile pane, displaying the stored one or more thread UIs in the tile pane; and
upon receiving a command relative to a selected thread UI in the tile pane, perform at least one of:
delete the selected thread UI;
share the selected thread UI with one or more recipients;
remove one or more thread UIs above the selected thread in the tile pane;
remove one or more thread UIs below the selected thread UI in the tile pane; and
keep only the selected thread UI in the tile pane.

16. The system of claim 12, wherein the threadanalyzer is further configured to upon determining the user traversed back on one or more sub-paths included within the path, remove or restore one or more UIs corresponding to the one or more sub-paths from the thread.

17. The system of claim 12, wherein the collaborator is further configured to:
receive a command for sending the stored thread to one or more recipients;
based upon the command, display an option for enclosing the thread as at least one of:
the link; and
the image file;
based upon the user selection of the option, enclose the thread in an email; and
upon receiving user's instruction, send the email to the one or more recipients.

18. A non-transitory computer readable medium to tangibly store instructions, which when executed by a computer, cause the computer to perform operations comprising:
upon receiving a command for recording a user interface (UI), record the UI;
save one or more recorded UIs as a thread, wherein the UIs within the thread are recorded in order of their received command of recording;
customize the thread based on at least one of: naming the thread and removing at least one UI from the one or more UIs included in the thread; and
store the customized thread.

19. The non-transitory computer readable medium of claim 18, wherein the thread is stored as at least one of:
a link comprising an address of an entry point of the thread; and
an image file comprising images of the one or more user interfaces included within the thread.

20. The non-transitory computer readable medium of claim 19, wherein at least one of the one or more UIs within the thread includes an option to display data in at least one of a real time and time when the at least one of the one or more UIs is recorded.
